(19) United States
(12) Patent Application Publication
(10) Pub. No.: US 2026/0169919 A1
(43) Pub. Date: Jun. 18, 2026

(54) PROGRESSIVE CLUTCH CACHE ARCHITECTURE

(71) Applicant: QUALCOMM Incorporated, San Diego, CA (US)

(72) Inventors: Saurabh Kumar SHRIMAL, Noida (IN); Sandeep DAGER, Ghaziabad (IN); Zhenyu QI, Brookline, MA (US); Lulu JI, Lexington, MA (US)

(21) Appl. No.: 18/986,589

(22) Filed: Dec. 18, 2024

(51) Int. Cl. G06F 12/0811

(52) U.S. Cl. CPC G06F 12/0811

(57) ABSTRACT

Aspects presented herein relate to methods and devices for graphics processing including an apparatus, e.g., a graphics processor. The apparatus may obtain an indication of data for a memory access process, wherein the data for the memory access process is associated with data processing. The apparatus may also determine whether space is available for the data and an address of the data in a cache. Further, the apparatus may store, based on space being available in the cache, the data and the address of the data in the cache; or refrain from storing, based on space being unavailable in the cache, the data and the address of the data in the cache.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor or display processing unit (DPU).

A graphics processor of a device may be configured to perform the processes in a graphics processing pipeline. Further, graphics processors may utilize cache architectures. However, there has developed an increased need for improved cache architectures.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processor, a graphics processing unit (GPU), a central processing unit (CPU), or any apparatus that may perform for graphics processing. The apparatus may obtain an indication of data for a memory access process, where the data for the memory access process is associated with data processing. The apparatus may also determine whether space is available for the data and an address of the data in a cache. The apparatus may also store, based on space being available in the cache, the data and the address of the data in the cache; or refrain from storing, based on space being unavailable in the cache, the data and the address of the data in the cache. Additionally, the apparatus may retrieve, based on storage of the data and the address of the data in the cache, the data and the address of the data from the cache; or retrieve, based on refrainment of the storage of the data and the address of the data in the cache, the data and the address of the data from at least one memory. The apparatus may also determine whether a requested address of the data is identical to the retrieved address of the data from the cache. Moreover, the apparatus may output, based on the requested address of the data being identical to the retrieved address of the data from the cache, the retrieved data from the cache; or output, based on the requested address of the data not being identical to the retrieved address of the data from the cache, the retrieved data from the at least one memory. The apparatus may also output an indication of storage of the data and the address of the data in the cache or refrainment of the storage of the data and the address of the data in the cache.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processing unit (GPU) in accordance with one or more techniques of this disclosure.

FIG. 3 is a diagram illustrating example processing components in accordance with one or more techniques of this disclosure.

FIG. 4 is a diagram illustrating an example GPU in accordance with one or more techniques of this disclosure.

FIG. 5 is a diagram illustrating an example GPU in accordance with one or more techniques of this disclosure.

FIG. 6 is a diagram illustrating an example mapping of a cache in accordance with one or more techniques of this disclosure.

FIG. 7 is a diagram illustrating an example cache architecture in accordance with one or more techniques of this disclosure.

FIG. 8 is a diagram illustrating an example cache utilization process in accordance with one or more techniques of this disclosure.

FIG. 9 is a diagram illustrating an example cache architecture in accordance with one or more techniques of this disclosure.

FIG. 10 is a graph illustrating results of an example cache utilization process in accordance with one or more techniques of this disclosure.

FIG. 11 is a diagram illustrating an example cache utilization process in accordance with one or more techniques of this disclosure.

FIG. 12 is a communication flow diagram illustrating example communications between a GPU, a GPU/CPU, and a memory in accordance with one or more techniques of this disclosure.

FIG. 13 is a flowchart of an example method of graphics processing in accordance with one or more techniques of this disclosure.

FIG. 14 is a flowchart of an example method of graphics processing in accordance with one or more techniques of this disclosure.

### DETAILED DESCRIPTION

In some aspects, a cache may be a small, high-speed memory area on a graphics processing unit (GPU) that stores frequently accessed data. The cache may act as a buffer between the GPU core and the main system memory (e.g., random access memory (RAM)) to speed up data retrieval. Also, the cache may improve the overall GPU performance by reducing latency for repeated data accesses. GPU caches may function in a similar manner to CPU caches, but they may be optimized for the parallel processing nature of GPUs. For instance, GPU caches may include different cache levels, such as level 1 (L1) and level 2 (L2). A GPU cache may store frequently used data in order to minimize the need to access slower main memory (e.g., RAM). The GPU cache levels (e.g., L1, L2) may utilize varying sizes and access speeds. Further, a specific block of data transferred between cache and main memory may be optimized for parallel access. Moreover, efficient use of caches may improve GPU performance, such as in graphics-intensive applications. Caches may store a number of different types of data. Prior to being stored, the data may be in a queue. For example, data that is waiting to be stored in a cache may be in a queue. A high amount of data may be waiting in a queue with a large depth. Likewise, a small amount of data may be waiting in a queue with a small depth. Reducing queue depth at caches may be of importance at certain types of cores (e.g., high performance cores such as a GPU, a CPU, or a neural processing unit (NPU)). Also, certain types of memory may not be able to bypass certain types of operations. For example, memory, write-read operations may not be bypassed for any out-of-order addresses. Additionally, certain types of memory (e.g., system memory or random access memory (RAM)) may have a high impact on GPU performance. For instance, system memory or RAM may utilize a high amount of power, performance, and area (PPA) budget at GPUs. The utilization of caches may help to reduce the impact on GPU performance for certain types of memory (e.g., system memory or RAM). For example, utilizing caches may help to reduce the amount of power, performance, and area (PPA) budget at GPUs for certain types of memory (e.g., system memory or RAM). In particular, optimizing the static RAM (SRAM) or dynamic RAM (DRAM) utilization and extensive access in such cases may be important to meet power, performance, and area (PPA) budget at GPUs. For instance, the SRAM and DRAM have a high power utilization and is costly to access for GPUs. As indicated herein, reducing queue depth may be a large challenge for high performance cores (e.g., GPU, CPU, NPU). SRAM utilization and extensive access in such cases may be important to meet PPA budgets at a GPU. With some types of memory, certain operations (e.g., write-read operations) may not be bypassed for any out-of-order addresses. Also, certain bypass RAM logic may be based on a depth check (e.g., a first-in, first-out (FIFO) depth check) and may have dependency on backpressure. As such, in some cases, this may produce a limited cache hit efficiency. Accordingly, this may not be energy efficient. That is, certain cache architectures may miss scenarios for cache hits and suffer unnecessary additional data buffer hardware cost, as memory is being accessed for longer periods of time and burning power. Additional memory accesses may consume a high amount of PPA at the GPU. Based on the above, it may be beneficial to utilize a certain types of caches/buffers for memory accesses (e.g., read, write, etc.). For example, it may be beneficial to utilize a power efficient cache/buffer for memory accesses (e.g., read, write, etc.). Aspects of the present disclosure may utilize a certain types of caches/buffers for memory accesses.

Aspects of the present disclosure may include a number of benefits or advantages. Aspects of the present disclosure may utilize a certain types of caches/buffers for memory accesses. For instance, aspects presented herein may utilize a power efficient cache/buffer (e.g., a clutch cache) for memory accesses (e.g., read, write, etc.). That is, aspects presented herein may utilize a certain type of cache/buffer (e.g., a clutch cache) and bypass certain memory accesses (e.g., read, write, etc.) in order to optimize the PPA utilization at the GPU. Aspects presented herein may also optimize a priority for storing data at a certain type of cache/buffer. For example, aspects herein may optimize a priority for storing data at a certain type of cache/buffer (e.g., a clutch cache) over other types of memory (e.g., system memory or RAM). That is, aspects herein may fill certain types of caches/buffers (e.g., a clutch cache) prior to other types of memory (e.g., system memory or RAM). By doing so, aspects presented herein may utilize more efficient types of caches/buffers over less efficient types of memory (e.g., system memory or RAM). In turn, this may reduce the amount of power utilized at a GPU, increase the performance of a GPU, and increase the amount of available storage area at a GPU. Indeed, aspects presented herein may optimize the power, performance, and area (PPA) utilized at a GPU.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended. In some examples, as used herein, the term “graphics workload” may refer to any workload or order associated with graphics processing. In some examples, as used herein, the term “texture fetch” may refer to a memory request, which incurs transactions from a cache (e.g., a texture cache). Each time a warp executes a texture function to read from texture memory, this may be a single texture fetch. Also, texture memory may be read-only device memory, and may be accessed using the device functions described in a texture function. Reading a texture using one of these functions may be called a “texture fetch.” A “render target” may refer to a target block of pixels (buffer) into which rendering will occur. In some aspects, a render target may refer to a buffer where the pixels are drawn (e.g., a video card draws pixels) for a scene that is being rendered in the background. An intermediate render target may refer to a render target that is used in post-processing.

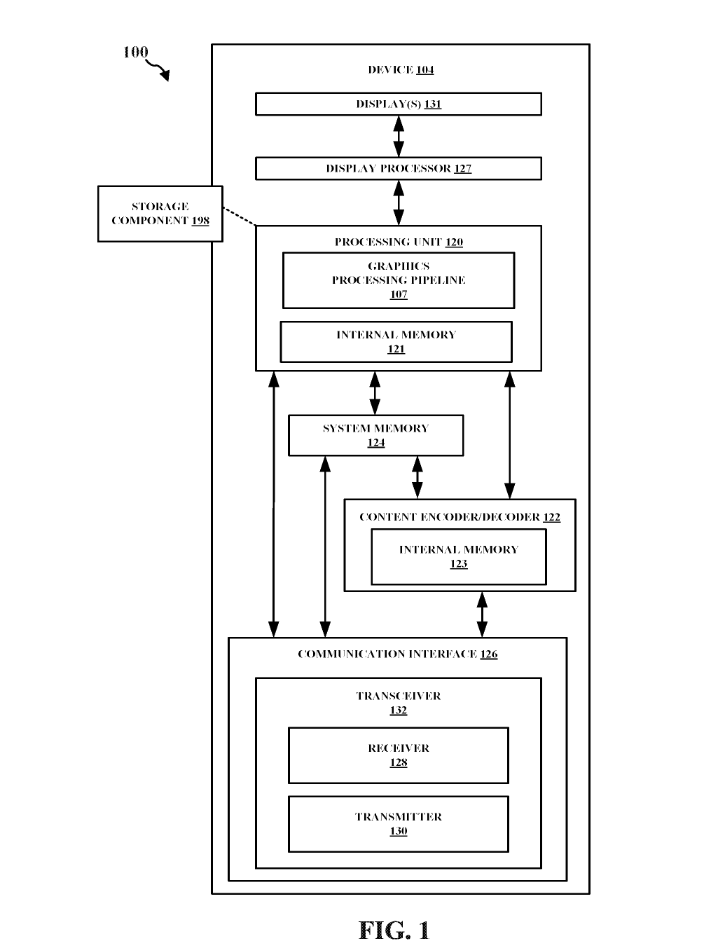

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a storage component 198 configured to obtain an indication of data for a memory access process, where the data for the memory access process is associated with data processing. The storage component 198 may also be configured to determine whether space is available for the data and an address of the data in a cache. The storage component 198 may also be configured to store, based on space being available in the cache, the data and the address of the data in the cache; or refrain from storing, based on space being unavailable in the cache, the data and the address of the data in the cache. The storage component 198 may also be configured to retrieve, based on storage of the data and the address of the data in the cache, the data and the address of the data from the cache; or retrieve, based on refrainment of the storage of the data and the address of the data in the cache, the data and the address of the data from at least one memory. The storage component 198 may also be configured to determine whether a requested address of the data is identical to the retrieved address of the data from the cache. The storage component 198 may also be configured to output, based on the requested address of the data being identical to the retrieved address of the data from the cache, the retrieved data from the cache; or output, based on the requested address of the data not being identical to the retrieved address of the data from the cache, the retrieved data from the at least one memory. The storage component 198 may also be configured to output an indication of storage of the data and the address of the data in the cache or refrainment of the storage of the data and the address of the data in the cache. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

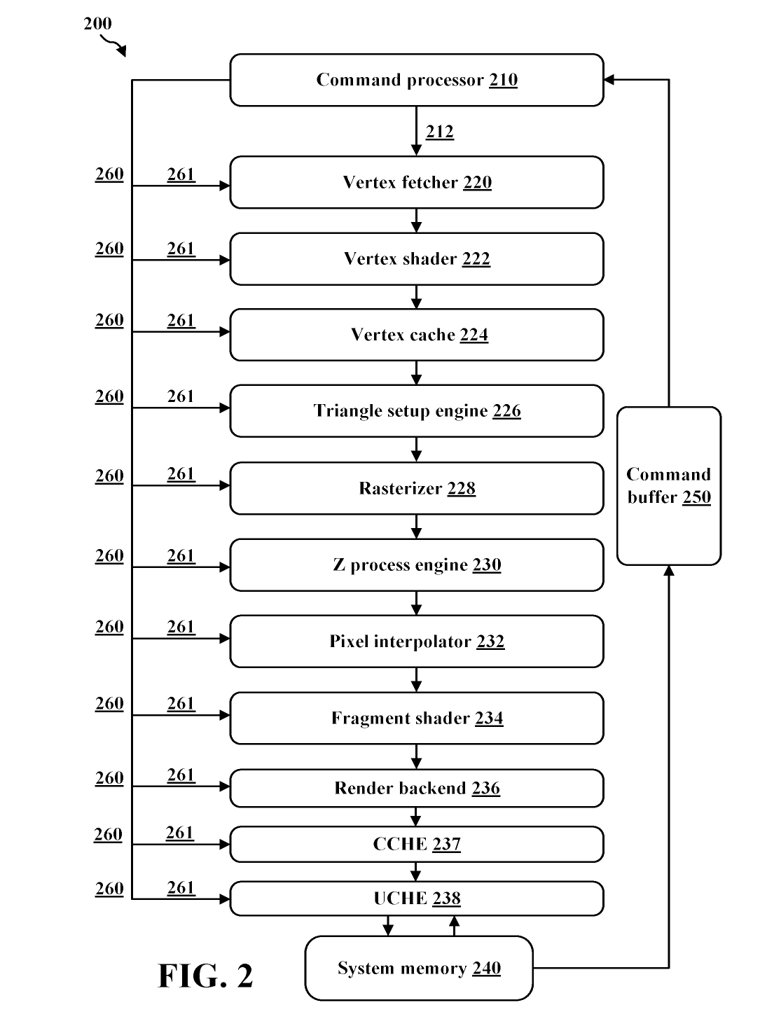

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in double data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

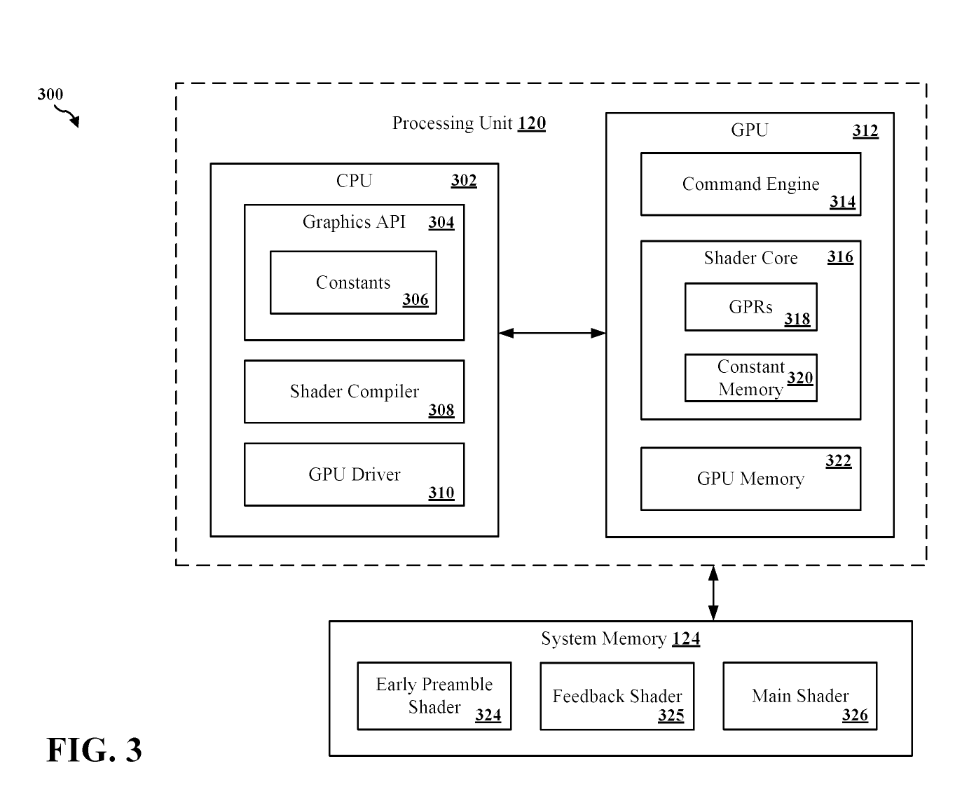

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

GPUs can render images in a variety of different ways. In some instances, GPUs can render an image using rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects, during a binning pass, an image can be divided into different bins or tiles. In some aspects, during the binning pass, a visibility stream can be constructed where visible primitives or draw calls can be identified. In contrast to tiled rendering, direct rendering does not divide the frame into smaller bins or tiles. Rather, in direct rendering, the entire frame is rendered at a single time. Additionally, some types of GPUs can allow for both tiled rendering and direct rendering.

In some aspects, GPUs can apply the drawing or rendering process to different bins or tiles. For instance, a GPU can render to one bin, and perform all the draws for the primitives or pixels in the bin. During the process of rendering to a bin, the render targets can be located in the GMEM. In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory used to drop primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

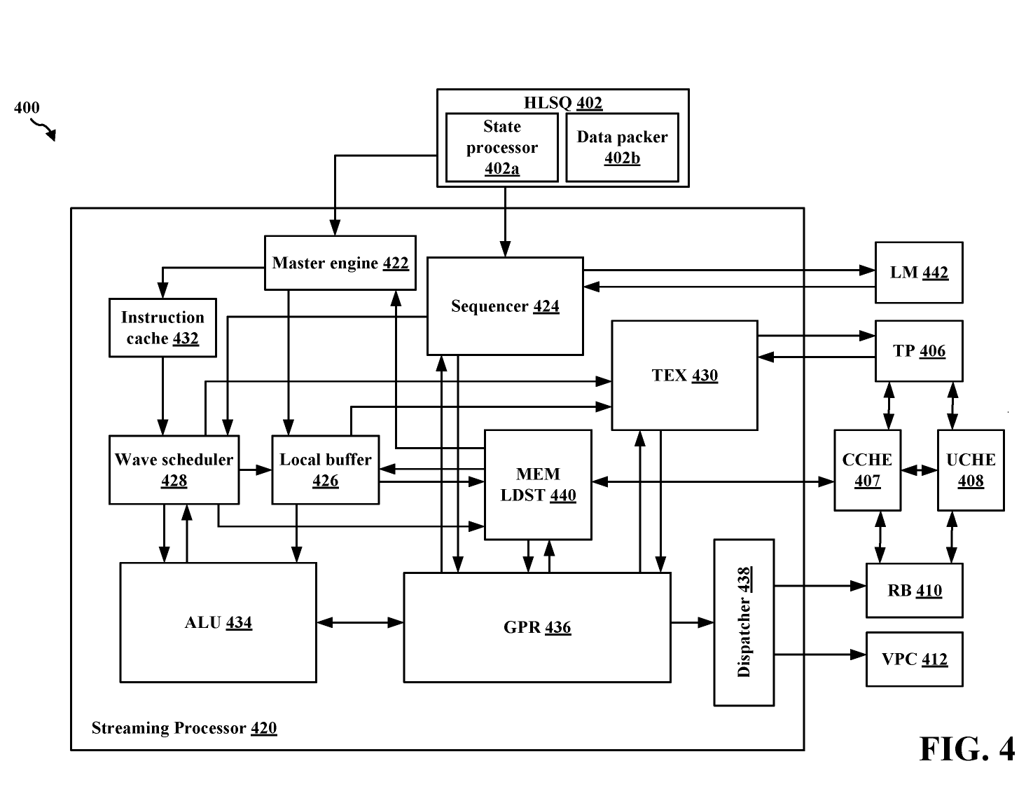

FIG. 4 illustrates an example GPU 400. Specifically, FIG. 4 illustrates a streaming processor (SP) system in GPU 400. As shown in FIG. 4, GPU 400 includes a high level sequencer (HLSQ) 402, texture processor (TP) 406, level 1 (L1) cache (cluster cache (CCHE)) 407, level 2 (L2) cache (UCHE) 408, render backend (RB) 410, and vertex cache (VPC) 412. GPU 400 also includes SP 420, master engine 422, sequencer 424, local buffer 426, wave scheduler 428, texture (TEX) 430, instruction cache 432, arithmetic logic unit (ALU) 434, GPR 436, dispatcher 438, and memory (MEM) load store (LDST) 440.

As shown in FIG. 4, each unit or block in GPU 400 may send data or information to other blocks. For instance, HLSQ 402 may send commands to the master engine 422. Also, HLSQ 402 may send vertex threads, vertex attributes, pixel threads, pixel attributes, and/or compute commands to the sequencer 424. TP 406 may receive texture requests from TEX 430, and send texture elements (texels) back to the TEX 430. Further, TP 406 may send memory read requests to and receive memory data from CCHE 407 or UCHE 408. CCHE 407 or UCHE 408 may also receive memory read or write requests from MEM LDST 440 and send memory data back to MEM LDST 440, as well as receive memory read or write requests from RB 410 and send memory data back to RB 410. Also, RB 410 may receive an output in the form of color from GPR 436, e.g., via dispatcher 438. VPC 412 may also receive output in the form of vertices from GPR 436, e.g., via dispatcher 438. GPR 436 may send address data or receive write back data from MEM LDST 440. GPR 436 may also send temporary data to and receive temporary data from ALU 434. Moreover, ALU 434 may send address or predicate information to the wave scheduler 428, as well as receive instructions from wave scheduler 428. Local buffer 426 may send constant data to ALU 434. TEX 430 may also receive texture attributes from or send texture data to GPR 436, as well as receive constant data from local buffer 426. Further, TEX 430 may receive texture requests from wave scheduler 428, as well as receive constant data from local buffer 426. MEM LDST 440 may send/receive constant data to/from local buffer 426. Sequencer 424 may send wave data to wave scheduler 428, as well as send/receive data to/from GPR 436. The sequencer 424 may allocate resources and local memory (e.g., local memory (LM) 442). Also, the sequencer 424 may allocate wave slots and any associated GPR 436 space. For example, the sequencer 424 may allocate wave slots or GPR 436 space when the HLSQ 402 issues a pixel tile workload to the SP 420. Master engine 422 may send program data to instruction cache 432, as well as send constant data to local buffer 426 and receive instructions from MEM LDST 440. Instruction cache 432 may send instructions or decode information to wave scheduler 428. Wave scheduler 428 may send read requests to local buffer 426, as well as send memory requests to MEM LDST 440.

As further shown in FIG. 4, the HLSQ 402 may prepare one or more context states for the SP 420. For example, the HLSQ 402 may prepare the context states for different types of data, e.g., global register data, shader constant data, buffer descriptors, instructions, etc. Additionally, the HLSQ 402 may embed context states into a command stream to the SP 420. The master engine 422 may parse the command stream from the HLSQ 402 and setup an SP global state. Moreover, the master engine 422 may fill or add to an instruction cache 432 and/or a local buffer 426 or a constant buffer. In some aspects, inside the HLSQ 402, there may be an internal function unit called a state processor 402a. The state processor 402a may be a single fiber scalar processor that may execute a special shader program, e.g., a preamble shader. The preamble shader may be generated by the GPU compiler in order to load constant data from different buffer objects. Also, the preamble shader may bind the buffer objects into a single constant buffer, such as a post-process constant buffer. Further, the HLSQ 402 may execute the preamble shader and, as a result, skip utilizing a main shader. In some instances, the main shader may perform different shading tasks, such as normal vertex shading and/or a fragment shading program. Moreover, the HLSQ 402 may include a data packer 402b.

Additionally, as shown in FIG. 4, the SP 420 may not be limited to executing a preamble if the HLSQ 402 decides to skip a preamble execution. For instance, the SP 420 may also process a conventional graphics workload, such as vertex shading and/or fragment shading. In some aspects, the SP 420 may utilize its execution units and storage in order to process compute tasks as a general purpose GPU (GPGPU). Inside the SP 420, there may be multiple parallel instruction execution units such as an ALU, elementary function unit (EFU), branching unit, TEX, general memory read and write (aka LDST), etc. The SP 420 may also include on-chip storage memory, such as a GPR 436 which may store per-fiber private data. Also, the SP 420 may include a local buffer 426 which stores per-shader or per-kernel constant data, per-wave uniform data (aka uGPR), and per-compute work group (WG) local memory (LM) (e.g., local memory (LM) 442). Processing a preamble shader may take up one wave slot. Further, the majority of preamble shaders may use just the uGPR and not the GPR, and may execute ALU instructions on a scalar ALU. Therefore, execution of the preamble shader may be associated with high performance, and may be power efficient because any available wave slot may be used to execute the preamble shader even without GPR space allocation.

Moreover, as shown in FIG. 4, dispatcher 438 may fetch data from GPR 436. Dispatcher 438 may also perform format conversion, and then dispatch a final color to multiple render targets (RTs). Each RT may have one or more components, such as red (r) green (G) blue (B) alpha (A) (RGBA) data, or just an alpha component of the RGBA data. Further, each RT may be generally stored in a vector GPR, i.e., R3.0 may store red data, R3.1 may store green data, R3.2 may store blue data, etc. Also, a driver program in an SP context register may be utilized to define the GPR identifier (ID) which stores RT data.

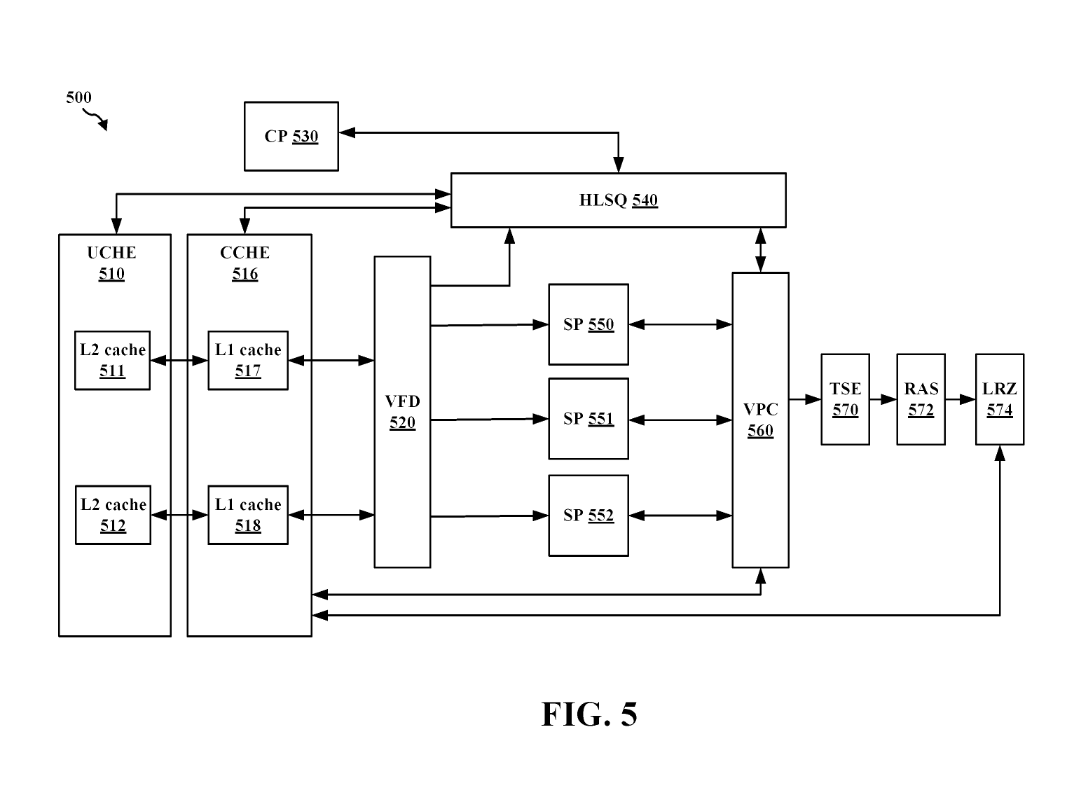

FIG. 5 is a diagram illustrating another example GPU. More specifically, FIG. 5 depicts GPU 500 including a number of different components. As shown in FIG. 5, GPU 500 includes UCHE 510 including L2 cache 511 and L2 cache 512, CCHE 516 including L1 cache 517 and L1 cache 518, VFD 520, CP 530, HLSQ 540, a number of SPs (e.g., SP 550, SP 551, and SP 552), VPC 560, TSE 570, RAS 572, and low resolution Z (LRZ) component (e.g., LRZ 574). As shown in FIG. 5, CP 530 may transmit data to HLSQ 540 and receive data from HLSQ 540. CCHE 516 may transmit/receive data to/from HLSQ 540. UCHE 510 may also transmit/receive data to/from HLSQ 540. L2 cache 511 and L2 cache 512 may transmit/receive data to/from VFD 520. Further, VFD 520 may transmit data to HLSQ 540, as well as transmit data to SPs 550-552. Moreover, SPs 550-552 may transmit/receive data to/from VPC 560. Also, VPC 560 may transmit/receive data to/from HLSQ 540. Data can also be transmitted from VPC 560 to TSE 570, which can transmit data to RAS 572, and then to LRZ 574. CCHE 516 can transmit/receive data to/from VPC 560 and LRZ 574. Also, UCHE 510 can transmit/receive data to/from VPC 560 and LRZ 574.

In aspects of graphics processing, some graphics applications may render to a single target, i.e., a render target, one or more times. For instance, in graphics rendering, a frame buffer on a system memory may be updated multiple times. The frame buffer may be a portion of memory or random access memory (RAM) (e.g., containing a bitmap or storage) to help store display data for a GPU. The frame buffer may also be a memory buffer containing a complete frame of data. Additionally, the frame buffer may be a logic buffer. In some aspects, updating the frame buffer may be performed in bin or tile rendering, where, as discussed above, a surface is divided into multiple bins or tiles and then each bin or tile may be separately rendered. Further, in tiled rendering, the frame buffer may be partitioned into multiple bins or tiles.

As indicated herein, graphics processors (e.g., GPUs) may work in a number of different fashions (e.g., a single instruction, multiple data (SIMD) fashion). GPUs may process certain types of instructions that are associated with an operation (e.g., an SIMD operation). For instance, a GPU may process wave instructions or waves, which are the width of data elements that are operated on by a single instruction associated with the SIMD. The term wave may also refer to a set of threads or blocks that run concurrently on the GPU. Waves may be allocated into sub-waves, which may include a number of threads or fibers. An active thread/fiber may refer to a thread/fiber that executes instructions (e.g., instructions in the ALU). An inactive thread/fiber may refer to a thread/fiber that does not execute instructions. Threads/fibers that do not partake in a branching operation may eventually become inactive (i.e., partake in the next level of the hierarchy). A kernel may be a programming operations manager or a programming thread at a GPU. Also, a kernel may be executed in parallel by an array of threads/fibers, where all threads/fibers may run the same code. Each thread/fiber may have an identifier (ID) that it uses to compute memory addresses and make control decisions. GPUs may also process a number of different operations, such as an atomic operation. An atomic operation may enable another operation (e.g., a read-modify-write operation or a read-write operation) to occur without any interruption. As such, an atomic operation may assure that no other execution operation at a GPU may have been inserted between the target operation (e.g., a read-modify-write operation or a read-write operation).

In some aspects, a shader in the context of a graphics processor (e.g., a GPU) may be a program that is used to control the rendering effects of 3D computer graphics. There are different types of shaders (e.g., vertex shaders, pixel shaders, and geometry shaders), each of which may handle a different aspect of the rendering process. Shaders may be used to produce realistic lighting, shadows, textures, and other visual effects in video games, simulations, and other 3D applications. A shader processor may utilize one or more context states to perform various operations and calculations. For instance, a shader processor may be part of multiple shared cores for integer processing. Also, a shader processor may execute shader code (e.g., vertex shaders, fragment shaders, compute shaders, etc.). The shader processor may also be referred to as a shader core. Shader code may also be referred to as a shader and may refer to a user-defined program configured to run in a stage of the GPU. In an example, the shader code may be associated with the rendering of graphical content. The shader processor may include a number of different components, such as arithmetic logic units (ALUs) and general purpose registers (GPRs). An ALU may be a combinatorial digital circuit that performs arithmetic and bitwise operations on integer binary numbers (e.g., a signed integer, an unsigned integer, etc.). A GPR may be a register that stores both data and addresses, that is, the GPR may be a combined data/address register. A register may refer to a location that may be accessed by a processor. A register may include a small amount of relatively quickly accessible storage.

As indicated herein, a kernel may be a programming operations manager or a programming thread at a GPU. Also, a kernel may be executed in parallel by an array of threads, where all threads may run the same code. Each thread may have an identifier (ID) that it uses to compute memory addresses and make control decisions. A warp may be a collection of threads (e.g., 32 threads) that are executed simultaneously by a symmetric multiprocessor (SM). A warp may be a basic unit of execution, where multiple warps may be executed on an SM at once. When a program on a CPU invokes a kernel grid, the blocks of the grid may be enumerated and distributed to SMs with available execution capacity. The threads of a thread block may execute concurrently on one SM, and multiple thread blocks may execute concurrently on one SM. As thread blocks terminate, new blocks are launched on the vacated SMs. The mapping between warps and thread blocks may affect the performance of the kernel. Also, a clock or GPU clock may be a logical beat or time that is used to synchronize actions of the GPU. A clock source may manage how a GPU component derives its clock.

A symmetric multiprocessor (SM) may be single instruction multiple thread processor which has multiple shared cores at a GPU (e.g., shader processors) for integer processing, special functional units (SFUs) (e.g., for calculating functions such as sine, cosine, root mean-squared (RMS), etc.). The SM may have load store (LD/ST) units for load and store into memory/registers. The SM may also have L1 caches, shared caches and large-banked register files. A concurrent thread array (CTA) may be a basic workload unit assigned to an SM in a GPU. Threads in a CTA may be sub-grouped into a warp/wavefronts, which is the smallest execution unit sharing the same program counter. A last level cache (LLC) may be a last level of cache from a GPUs context, such as an extended cache for SMs. An interconnect unit may be a crossbar switch which does multi-master arbitration, by which GPUs are connected to rest of the world. Further, a pointer of serialization / pointer of coherence (PoS/PoC) may be point in the system-on-chip (SoC) post where every master in the system may see the same coherent copy of data.

Some aspects of graphics processing may utilize certain GPU architectures and/or application structures. For instance, aspects of graphics processing may utilize a general purpose GPU (GPGPU) architecture that includes symmetric multiprocessor (SMs), shared cores, an interconnect unit, a dynamic random access memory (DRAM), and/or a number of different caches (e.g., a first level (L1) cache, a second level (L2) cache, and/or a last level cache (LLC)). In some instances of GPU architectures, a number of SMs, shared cores, and L1 caches may be connected to an interconnect unit. The interconnect unit may be connected to L2 caches and DRAMs. Additionally, in an application structure, an application may include a number of kernels, and each of the kernels may include concurrent thread arrays (CTAs), where each CTA includes a number of warps.

Some types of GPUs may include a number of different types of registers or memory, such as general purpose registers (GPRs). A GPR may be a register that stores both data and addresses. That is, the GPR may be a combined data/address register. In some architectures, a register file may be unified so that a GPR may store certain types of numbers (e.g., floating-point numbers). A register may refer to a location that may be accessed by a processor. Additionally, a register may include a small amount of relatively quickly accessible storage. GPUs may include other types of memory, such as graphics memory (GMEM) or on-chip memory, which may store data or data buffers.

As depicted in FIG. 5, GPUs (e.g., GPU 500) may include a number of different caches. GPUs utilize caches for a variety of reasons, such as to transfer data at a sufficiently high rate of speed. That is, as processing power for GPUs has increased at a higher rate than memory access speed, storage resources (e.g., caches) between the processor and memory have been utilized to transfer data at a sufficient rate. Caches at GPUs are also utilized to more seamlessly transfer data. One benefit of caches is that they provide buffering, so caches and buffers may be similar. For instance, caches may decrease latency by reading data from memory in larger chunks based on subsequent data accessing nearby address locations. Also, caches may increase throughput by assembling multiple small transfers into larger, more efficient memory requests. These benefits may be achieved by a cache storing data in blocks called cache lines. A cache line may be a portion of data that can be mapped into a cache. For example, a cache line may be a smallest portion of data that can be mapped into a cache.

In some aspects, each mapped cache line may be associated with a block (e.g., a core line), which is a corresponding region on a main memory or a backend storage). A backend storage may allow performance for the cache and GPU to improve. For example, database caching may allow an increased throughput and a reduced data retrieval latency associated with backend databases, which may improve the overall performance of the cache and GPU. Also, in some aspects, both the cache and main memory/backend storage may be divided into blocks of the size of a cache line. Further, all the cache mappings may be aligned to these blocks. Cache lines may have a certain size (e.g., between 32 to 512 bytes), and memory transactions may be performed in units of cache lines. Individual cache accesses made by code that executes on a GPU processor may be smaller than these units of cache lines (e.g., 4 bytes).

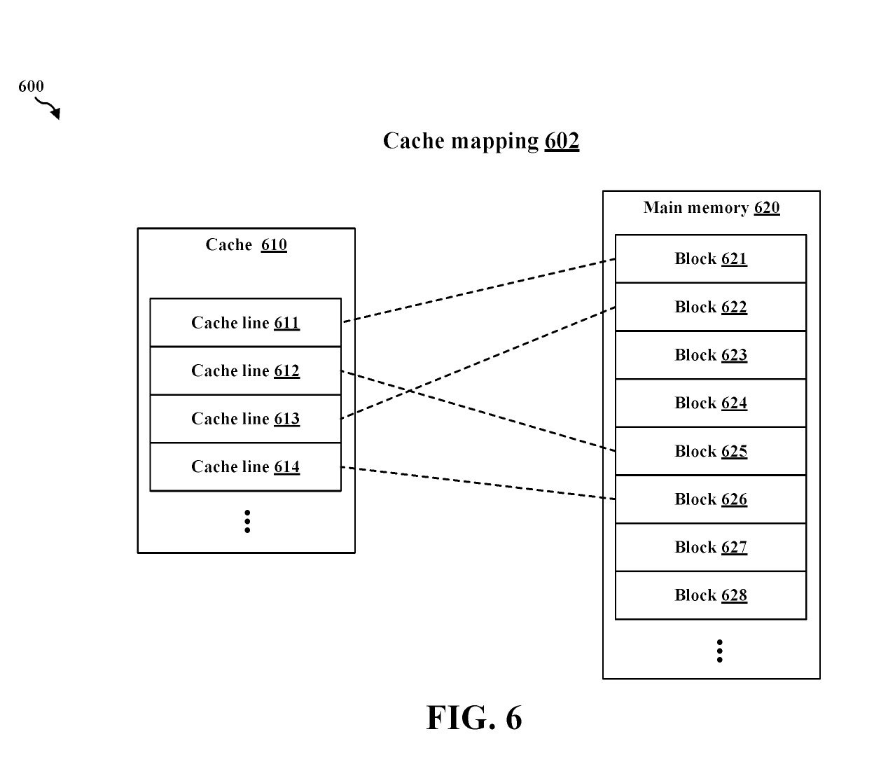

FIG. 6 is a diagram 600 illustrating an example mapping of a cache. More specifically, FIG. 6 depicts a cache mapping 602 for a cache 610 and a main memory 620. That is, FIG. 6 depicts the relationship between cache lines in cache 610 (e.g., cache line 611, cache line 612, cache line 613, and cache line 614) and blocks in main memory 620 (e.g., block 621, block 622, block 623, block 624, block 625, block 626, block 627, and block 628). As shown in FIG. 6, diagram 600 illustrates that individual blocks 621-628 may be directly mapped to individual cache lines 611-614. For example, as illustrated in diagram 600, block 621 may be mapped to cache line 611, block 622 may be mapped to cache line 613, block 625 may be mapped to cache line 612, and block 626 may be mapped to cache line 614. Some of the blocks 621-628 may not be directly mapped to cache lines 611-614. For instance, block 623, block 624, block 627, and block 628 may not be directly mapped to cache lines 611-614. In some aspects, main memory 620 including blocks 621-628 may be a backend storage including a number of core lines.

Valid data (e.g., valid bits) and dirty data (e.g., dirty bits) may correspond to a current cache line state. For instance, when a cache line is valid (i.e., in a valid state) it may refer to the cache line being mapped to a block in main memory (e.g., a core line determined by a core identifier (ID) and a core line number). When a cache line is invalid (i.e., in an invalid state), it may be used to map a core line accessed by a certain request (e.g., an input/output (I/O) request), and the cache line may become valid thereafter. A cache line may return to an invalid state based on a number of different reasons. For example, a cache line may return to an invalid state: if the cache line is being evicted, if the core pointed to by the core ID is being removed, if the core pointed to by the core ID is being purged, if the entire cache is being purged, during a discard operation being performed on a corresponding core line, or during a certain request (e.g., an I/O request) when a cache mode which may perform an invalidation is selected.

In some aspects, dirty data or modified data may refer to data that is associated with a block of memory and indicates whether the corresponding block of memory has been modified. For example, a dirty bit or modified bit may be a bit that is associated with a block of memory and indicates whether the corresponding block of memory has been modified. The dirty data (e.g., dirty bit) may be set when a processor writes to (i.e., modifies) this memory. For instance, the dirty data (e.g., dirty bit) may indicate that its associated block of memory has been modified and has not been saved to storage yet. That is, “dirty data” may refer to data in a cache that is modified, but the memory still has an old or stale copy of the data. In some instances, when a block of memory is to be replaced, its corresponding dirty data (e.g., dirty bit) may be checked to determine if the block may need to be written back to secondary memory before being replaced or if it can simply be removed. Moreover, dirty data (e.g., dirty bit) may determine if the cache line data stored in the cache is in synchronization with corresponding data on the backend storage. For instance, if a cache line is dirty, then data on the cache storage may be up to date, and the data may need to be flushed (i.e., removed) at some point in the future (e.g., after the flushing the data may be marked as clean by zeroing a dirty bit). Also, a cache line may be considered valid if at least one of its sectors is valid. Likewise, a cache line may be considered dirty if at least one of its sectors is dirty.

In some instances, a goal of caches in GPUs may be to increase the performance of repeated accesses to the same data, as caches may keep a copy of a subset of the data in memory. Accordingly, subsequent accesses of the data already in the cache may not utilize an expensive memory access transaction. As some caches may have a smaller capacity than the memory size of the GPU system, the currently-cached data set may continuously change. This continuously change in cached data may be due to the memory access pattern of the executed code and/or the data replacement policy of the cache. This performance improvement may be important for GPUs, as GPUs may serve numerous simultaneously running threads with data.

Caches may receive a number of requests (e.g., data or content requests) to store or cache data. A cache hit may refer to an event when data requested for processing (e.g., requested by a component or application) is successfully retrieved from the cache memory. For example, a cache hit may describe when data or content is successfully found in the cache. That is, a cache hit may be when a system or application makes a request to retrieve data from a cache, and the specific data is currently in cache memory. A cache miss may refer to an event when data requested for processing (e.g., requested by a component or application) is not successfully retrieved from the cache memory. For example, a cache miss may describe when data or content is not successfully found in the cache. That is, a cache miss may be when a system or application makes a request to retrieve data from a cache, but that specific data is not currently in cache memory. Caches may be measured based on an amount of data requests that the cache is able to successfully fill.

There are a number of different types of caches that are utilized by GPUs. For instance, there are fully-associative caches, direct-mapped caches, and set-associative cache. A fully-associative cache may utilize a least recently used (LRU) cache policy, where there are a number of cells (e.g., M cells) that are each capable of holding a cache line corresponding to any of the memory locations (e.g., N memory locations). In the case of cache contention, the cache line that is not accessed the longest may be kicked out and replaced with a new cache line. A direct-mapped cache may directly map a block of memory to a single cache line which it can occupy. A set-associative cache may divide the address space into equal groups, which separately act as small fully-associative caches.

An associativity of a cache may refer to the size of the cache sets, or, i.e., how many different cache lines each data block can be mapped to. That is, the associativity of a cache may refer to a number of cache lines that are associated with a cache set for the cache. A cache set may include the number of cache lines in the cache. A higher associativity may result in a more efficient utilization of a cache, but may also increase the power/cost utilized by the cache. Likewise, a lower associativity may decrease the power/cost utilized by the cache, but may result in a less efficient utilization of the cache. The capacity of a cache may refer to the amount of data or information that can be stored in the cache. Additionally, the capacity or associativity of the cache may be adjusted based on a number of different factors of the GPU.

In addition to the global memory, GPUs may have local memory. Local memory is a temporary memory (e.g., a scratchpad memory) that is available during the embed process. Each shader processor may have a certain amount of memory (e.g., 32 kB of local memory). In some aspects, the shader processor may determine that certain programs may not even use local memory. For instance, when there is a program which uses both local and global memory, the difference may be that values belonging to global memory are cacheable. That is, immediately after the value can be cached, if it is not needed immediately, it can go back to the DRAM. In some aspects, when a particular value is brought into local memory, it may stay there and does not get replaced. So, the value may be moved from local memory and back to the global memory manually by the software. In some instances, the local memory may have a small latency (e.g., a latency of two cycles).

In some aspects, a cache may be a small, high-speed memory area on a graphics processing unit (GPU) that stores frequently accessed data. The cache may act as a buffer between the GPU core and the main system memory (e.g., random access memory (RAM)) to speed up data retrieval. Also, the cache may improve the overall GPU performance by reducing latency for repeated data accesses. GPU caches may function in a similar manner to CPU caches, but they may be optimized for the parallel processing nature of GPUs. For instance, GPU caches may include different cache levels, such as level 1 (L1) and level 2 (L2). A GPU cache may store frequently used data in order to minimize the need to access slower main memory (e.g., RAM). The GPU cache levels (e.g., L1, L2) may utilize varying sizes and access speeds. Further, a specific block of data transferred between cache and main memory may be optimized for parallel access. Moreover, efficient use of caches may improve GPU performance, such as in graphics-intensive applications.

Caches may store a number of different types of data. Prior to being stored, the data may be in a queue. For example, data that is waiting to be stored in a cache may be in a queue. A high amount of data may be waiting in a queue with a large depth. Likewise, a small amount of data may be waiting in a queue with a small depth. Reducing queue depth at caches may be of importance at certain types of cores (e.g., high performance cores such as a GPU, a CPU, or a neural processing unit (NPU)). Also, certain types of memory may not be able to bypass certain types of operations. For example, memory, write-read operations may not be bypassed for any out-of-order addresses.

Additionally, certain types of memory (e.g., system memory or random access memory (RAM)) may have a high impact on GPU performance. For instance, system memory or RAM may utilize a high amount of power, performance, and area (PPA) budget at GPUs. The utilization of caches may help to reduce the impact on GPU performance for certain types of memory (e.g., system memory or RAM). For example, utilizing caches may help to reduce the amount of power, performance, and area (PPA) budget at GPUs for certain types of memory (e.g., system memory or RAM). In particular, optimizing the static RAM (SRAM) or dynamic RAM (DRAM) utilization and extensive access in such cases may be important to meet power, performance, and area (PPA) budget at GPUs. For instance, the SRAM and DRAM have a high power utilization and is costly to access for GPUs.

As indicated herein, reducing queue depth may be a large challenge for high performance cores (e.g., GPU, CPU, NPU). SRAM utilization and extensive access in such cases may be important to meet PPA budgets at a GPU. With some types of memory, certain operations (e.g., write-read operations) may not be bypassed for any out-of-order addresses. Also, certain bypass RAM logic may be based on a depth check (e.g., a first-in, first-out (FIFO) depth check) and may have dependency on backpressure. As such, in some cases, this may produce a limited cache hit efficiency. Accordingly, this may not be energy efficient. That is, certain cache architectures may miss scenarios for cache hits and suffer unnecessary additional data buffer hardware cost, as memory is being accessed for longer periods of time and burning power. Additional memory accesses may consume a high amount of PPA at the GPU. Based on the above, it may be beneficial to utilize a certain types of caches/buffers for memory accesses (e.g., read, write, etc.). For example, it may be beneficial to utilize a power efficient cache/buffer for memory accesses (e.g., read, write, etc.). That is, it may be beneficial to utilize a certain type of cache/buffer and bypass certain memory accesses (e.g., read, write, etc.) in order to optimize the PPA utilization at the GPU. It may also be beneficial to optimize a priority for storing data at a certain type of cache/buffer. For instance, it may be beneficial to optimize a priority for storing data at a certain type of cache/buffer over other types of memory. Indeed, it may be beneficial to fill certain types of caches/buffers prior to other types of memory.

Aspects of the present disclosure may utilize a certain types of caches/buffers for memory accesses. For instance, aspects presented herein may utilize a power efficient cache/buffer (e.g., a clutch cache) for memory accesses (e.g., read, write, etc.). That is, aspects presented herein may utilize a certain type of cache/buffer (e.g., a clutch cache) and bypass certain memory accesses (e.g., read, write, etc.) in order to optimize the PPA utilization at the GPU. Aspects presented herein may also optimize a priority for storing data at a certain type of cache/buffer. For example, aspects herein may optimize a priority for storing data at a certain type of cache/buffer (e.g., a clutch cache) over other types of memory (e.g., system memory or RAM). That is, aspects herein may fill certain types of caches/buffers (e.g., a clutch cache) prior to other types of memory (e.g., system memory or RAM). By doing so, aspects presented herein may utilize more efficient types of caches/buffers over less efficient types of memory (e.g., system memory or RAM). In turn, this may reduce the amount of power utilized at a GPU, increase the performance of a GPU, and increase the amount of available storage area at a GPU. Indeed, aspects presented herein may optimize the power, performance, and area (PPA) utilized at a GPU.

Aspects presented herein may optimize the PPA utilization at a GPU for certain memory accesses (e.g., system memory, RAM, or static RAM (SRAM) accesses) by implementing a certain type of cache (e.g., clutch cache). For instance, as the system memory or SRAM has a high power utilization and is costly to access, aspects presented herein utilize a more power efficient cache/buffer for memory accesses (e.g., read, write, etc.). So aspects presented herein may implement a certain type of cache/buffer (e.g., clutch cache/buffer) and bypass the system memory or SRAM accesses (e.g., read, write, etc.) in order to optimize the PPA utilization at the GPU. Aspects herein may implement a higher priority for the clutch cache/buffer over the SRAM. So first the clutch cache/buffer will be filled, and once the clutch cache is filled, then aspects herein may start filling (e.g., writing to) the system memory or SRAM. For example, with a cache depth of N, in the first N cycles, aspects herein may write to the clutch cache/buffer, and then read from the clutch cache/buffer (e.g., a buffer may be utilized for a single depth, a cache may be utilized for two or more depths). As such, aspects presented herein may provide a small register cache (e.g., a clutch cache) to fill before other types of memory (e.g., system memory or SRAM). That is, if the clutch cache is filled first, then it may be accessed before other costly types of memory (e.g., system memory or SRAM).

In some instances, aspects herein may utilize a clutch cache implementation to optimize memory power by converting costly SRAM access to cost efficient regulation access by using sequential access properties of a queue. Aspects herein may reduce the memory accesses by adding a proposed clutch cache architecture with minimal hardware and to maximize a cache hit efficiency. By doing so, this may improve memory power and improve the overall PPA. In some instances, this may provide a high improvement in the efficiency of a GPU (e.g., provide a 4x efficiency improvement). Also, aspects herein may keep some amount of data inside the clutch cache (e.g., wallet) first for quick access/retrieval. Further, aspects herein may use a queue property of sequential write and reads (e.g., a first-in, first-out (FIFO) which may help to reduce costly memory accesses both from write and reads for out-of-order accesses. Additionally, aspects herein may utilize a proposed cache architecture to maintain a register cache to fill first, instead of memory. That is, if the clutch cache is filled first, then memory can be accessed from the clutch cache first. Additionally, aspects herein may utilize a proposed architecture that is specialized to reduce accesses for certain types of memory (e.g., system memory and SRAM), as well as utilize in a cache architecture maintain a certain cache/buffer (e.g., a clutch cache) that is filled with a high efficiency. By doing so, this may keep the switching of data and address registers to a minimum, which may in turn save power at the GPU.

Aspects presented herein (e.g., a GPU) may obtain an indication of data for a memory access process, where the data for the memory access process is associated with data processing. For example, a GPU may receive an indication of data for a memory access process from a GPU or CPU. Aspects presented herein (e.g., a GPU) may also determine whether space is available for the data and an address of the data in a cache (e.g., a clutch cache). For example, a GPU may determine whether space is available for the data and an address of the data in a cache (e.g., a clutch cache). Aspects presented herein (e.g., a GPU) may also store, based on space being available in the cache, the data and the address of the data in the cache; or refrain from storing, based on space being unavailable in the cache, the data and the address of the data in the cache (e.g., a clutch cache). For example, a GPU may store, based on space being available in the cache, the data and the address of the data in the cache (e.g., a clutch cache). Further, a GPU may refrain from storing, based on space being unavailable in the cache, the data and the address of the data in the cache (e.g., a clutch cache). That is, a GPU may store, based on space being unavailable in the cache, the data and the address of the data in at least one memory (e.g., system memory or SRAM). Additionally, aspects presented herein (e.g., a GPU) may retrieve, based on storage of the data and the address of the data in the cache, the data and the address of the data from the cache; or retrieve, based on refrainment of the storage of the data and the address of the data in the cache, the data and the address of the data from at least one memory. For example, a GPU may retrieve, based on storage of the data and the address of the data in the cache (e.g., a clutch cache).

Additionally, in some aspects, a GPU may retrieve, based on refrainment of the storage of the data and the address of the data in the cache, the data and the address of the data from at least one memory (e.g., system memory or SRAM). Aspects presented herein (e.g., a GPU) may also determine whether a requested address of the data is identical to the retrieved address of the data from the cache. For example, a GPU may determine whether a requested address of the data is identical to the retrieved address of the data from the cache (e.g., a clutch cache). Moreover, aspects herein (e.g., a GPU) may output, based on the requested address of the data being identical to the retrieved address of the data from the cache, the retrieved data from the cache. For example, a GPU may output, based on the requested address of the data being identical to the retrieved address of the data from the cache, the retrieved data from the cache (e.g., a clutch cache). Also, aspects herein (e.g., a GPU) may output, based on the requested address of the data not being identical to the retrieved address of the data from the cache, the retrieved data from the at least one memory. For example, a GPU may output, based on the requested address of the data not being identical to the retrieved address of the data from the cache, the retrieved data from the at least one memory (e.g., system memory or SRAM). Aspects presented herein (e.g., a GPU) may also output an indication of storage of the data and the address of the data in the cache or refrainment of the storage of the data and the address of the data in the cache.

Additionally, aspects presented herein may provide a certain cache architecture (e.g., a clutch cache architecture) to a GPU. This proposed cache architecture (e.g., a clutch cache architecture) may maintain a small, register cache (e.g., a clutch cache) at a GPU. When filling a cache with data, aspects herein may fill the register cache (e.g., a clutch cache) before other types of memory (e.g., system memory or SRAM). Once the cache (e.g., a clutch cache) is filled with data, then the other types of memory (e.g., system memory or SRAM) may be accessed. For instance, the proposed cache architecture may be specialized for certain types of memory (e.g., system memory or SRAM) that is utilized in queues, such that the proposed cache architecture may fill and access data from the cache (e.g., a clutch cache) prior to those types of memory. Also, the proposed cache architecture may try to maintain the cache (e.g., a clutch cache) to be filled with a highest efficiency or clutch depth (CD) compared to other types of memory. For example, aspects herein may keep switching of data and/or address registers to a minimum in order to save power. In some instances, aspects herein may keep some amount of data inside the cache (e.g., a clutch cache or wallet) for quick use/retrieval. If data is needed, aspects herein may retrieve the data from the clutch cache before retrieving data from other memory (e.g., system memory or SRAM). For instance, aspects herein may use a queue property of sequential operations (e.g., writes and reads) in a certain order (e.g., first-in, first-out (FIFO)). By doing so, aspects herein may reduce the amount of costly memory accesses. For example, aspects herein may reduce the amount of memory accesses from certain operations (e.g., write/reads and/or out-of-order accesses).

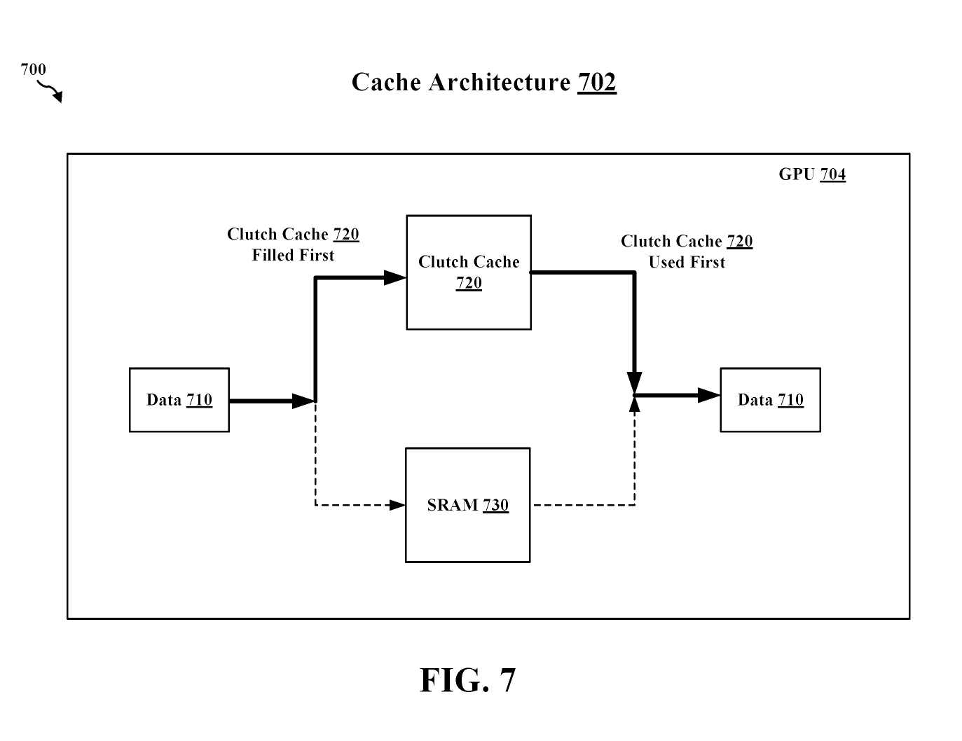

FIG. 7 illustrates diagram 700 including one example of a cache architecture. More specifically, diagram 700 depicts an example cache architecture 702 for a GPU. As shown in FIG. 7, diagram 700 includes GPU 704, data 710, clutch cache 720, and SRAM 730 (or other RAM or system memory). As depicted in FIG. 7, data 710 may be filled in the clutch cache 720 before it is filled in the SRAM 730. That is, data 710 may be filled first in the clutch cache 720 prior to other types of memory (e.g., system memory or SRAM 730). Also, data may be retrieved and/or used from the clutch cache 720 before it is retrieved and/or used from the SRAM 730. That is, data 710 may be retrieved and/or used from the clutch cache 720 prior to other types of memory (e.g., system memory or SRAM 730).

As shown in FIG. 7, the proposed cache architecture utilized herein may fill and access data from the cache (e.g., clutch cache 720) prior to those types of memory (e.g., system memory or SRAM 730). The proposed cache architecture may try to maintain the cache (e.g., clutch cache 720) to be filled with a highest efficiency or clutch depth (CD) compared to other types of memory (e.g., system memory or SRAM 730). For example, GPU 704 may keep switching of data 710 and/or address registers to a minimum in order to save power. In some instances, GPU 704 may keep some amount of data 710 inside the cache (e.g., clutch cache 720) for quick use/retrieval. If data 710 is needed, GPU 704 may retrieve the data 710 from the clutch cache 720 before retrieving data from other memory (e.g., SRAM 730). Additionally, GPU 704 may use a queue property of sequential operations (e.g., writes and reads) in a certain order (e.g., first-in, first-out (FIFO). By doing so, GPU 704 may reduce the amount of costly memory accesses. For example, GPU 704 may reduce the amount of memory accesses from certain operations (e.g., write/reads and/or out-of-order accesses).

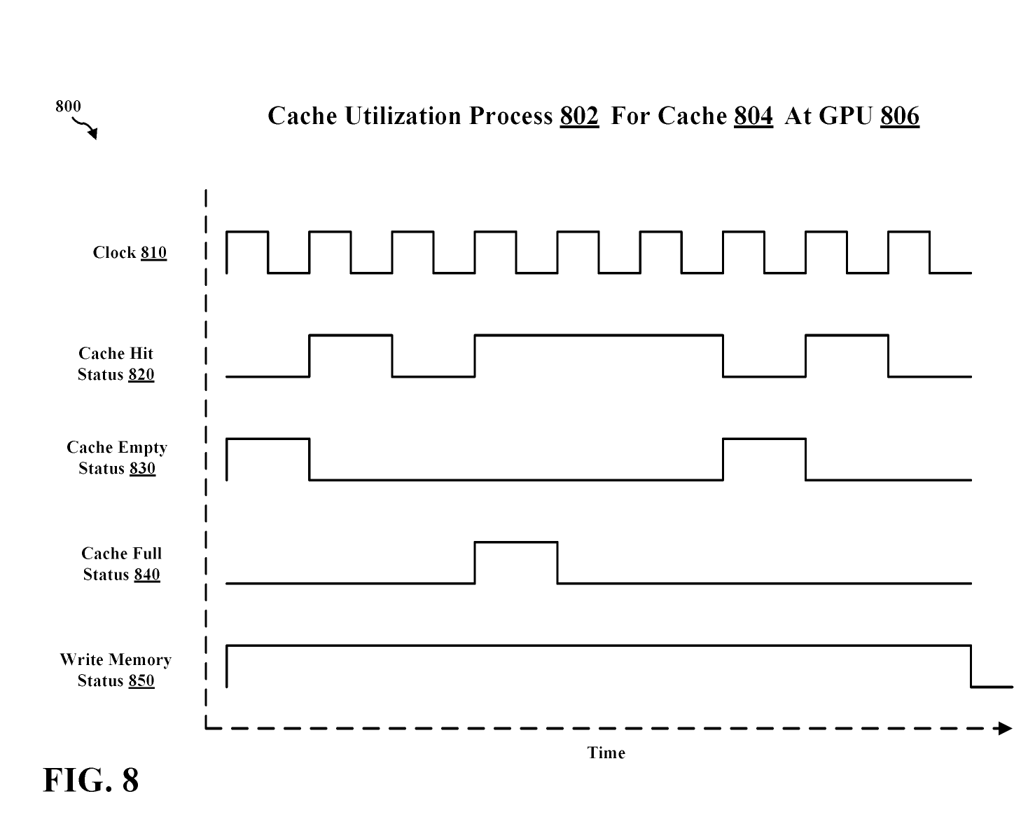

FIG. 8 illustrates diagram 800 including one example of a cache utilization process. More specifically, diagram 800 depicts an example cache utilization process 802 for cache 804 at GPU 806. As shown in FIG. 8, diagram 800 includes cache 804, GPU 806, clock 810, cache hit status 820, cache empty status 830, cache full status 840, and write memory status 850. As depicted in FIG. 8, clock 810 can keep a steady time at GPU 806. Cache hit status 820 may depict when a cache hit occurs at cache 804. For example, when the line at cache hit status 820 is up, there is a cache hit at cache 804. When the line at cache hit status 820 is down, there is not a cache hit at cache 804. Cache empty status 830 may depict when the cache 804 is empty. For example, when the line at cache empty status 830 is up, cache 804 is empty. Likewise, cache full status 840 may depict when the cache 804 is empty. When the line at cache full status 840 is up, cache 804 is empty. Write memory status 850 may depict when the write memory is saved at cache 804. For example, when the when the line at write memory status 850 is up, the write memory is saved at cache 804. FIG. 8 illustrates that aspects herein may allow GPU 806 to reduce the amount of costly memory accesses. For example, GPU 806 may reduce the amount of memory accesses from certain operations (e.g., write/reads and/or out-of-order accesses), as shown by write memory status 850.

In some instances, aspects presented herein may utilize a cache (e.g., a clutch cache) that is instantiated is a certain orientation (e.g., parallel to a system memory or SRAM). For instance, aspects herein may fill the cache (e.g., a clutch cache) before other types of memory (e.g., a system memory or SRAM). In some aspects, once the cache (e.g., a clutch cache) is filled, data may be routed to other types of memory (e.g., a system memory or SRAM). For example, once the cache (e.g., a clutch cache) is filled, input data may be routed by a certain component (e.g., a finite state machine (FSM)) to certain types of memory (e.g., a system memory or SRAM). In some cases, the cache (e.g., a clutch cache) may completely bypass certain types of memory (e.g., a system memory or SRAM). For example, for a certain instruction (e.g., “Wr Pointer - Rd pointer < Clutch Size”), the clutch cache may completely bypass the memory (e.g., a system memory or SRAM). In some examples, the clutch cache may not exert any back pressure to another component (e.g., an upstream block). Also, while reading data, the clutch cache may compare one address (e.g., a read (rd) address (addr)) with another address (e.g., a current addr). If the addresses match, the clutch cache may push the data out of the cache. Aspects herein may also utilize cache architecture that provides a cache hit for each type of data (e.g., switched data). This may make the GPU highly efficient and have a cumulative low power utilization.

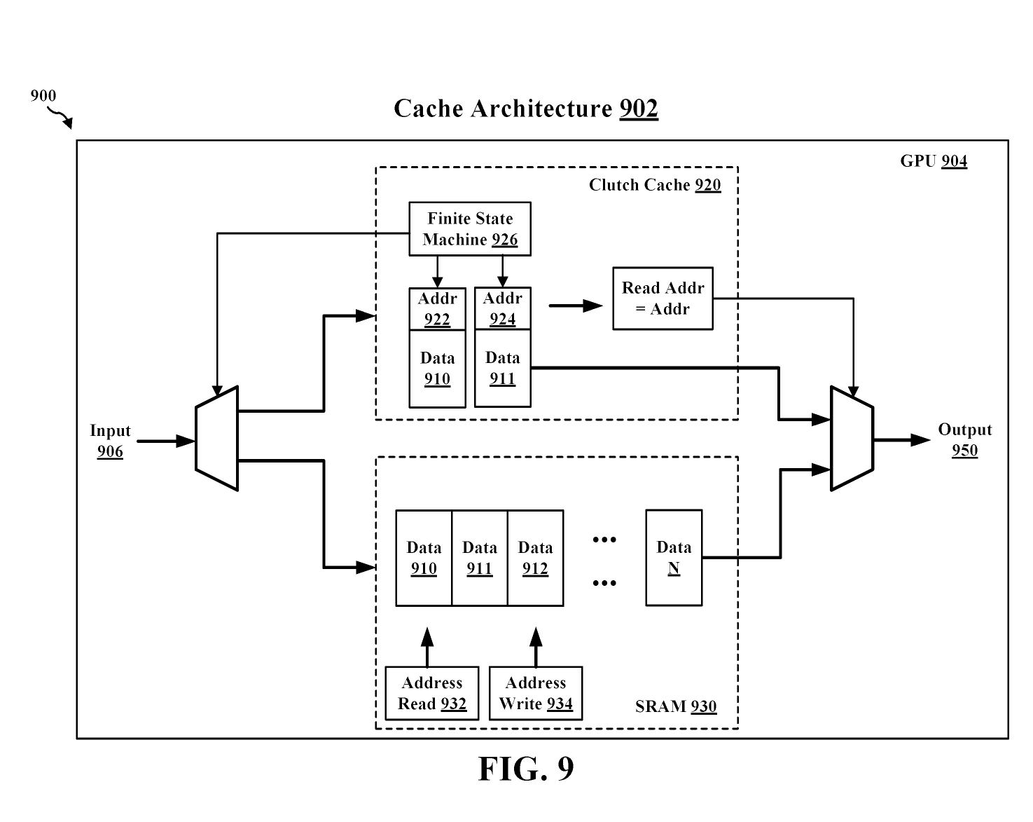

FIG. 9 illustrates diagram 900 including one example of a cache architecture. More specifically, diagram 900 depicts an example cache architecture 902 for a GPU. As shown in FIG. 9, diagram 900 includes GPU 904, input data 906, data 910, data 911, data 912, clutch cache 920, address 922, address 924, finite state machine 926, SRAM 930, address read 932, address write 934, and output data 950. As depicted in FIG. 9, input data 906 may be filled in the clutch cache 920 before it is filled in the SRAM 930. That is, input data 906 may be filled first in the clutch cache 920 prior to other types of memory (e.g., system memory or SRAM 930). Also, data may be retrieved and/or used from the clutch cache 920 before it is retrieved and/or used from the SRAM 930. That is, input data 906 may be retrieved and/or used from the clutch cache 920 prior to other types of memory (e.g., system memory or SRAM 930). The input data 906 may be first routed to clutch cache 920, which is stored as data 910 (with corresponding address 922) and data 911 (with corresponding address 924). As shown in FIG. 9, the read address may be equal to (i.e., identical to) the address.

Additionally, once clutch cache 920 is filled, data (e.g., data 910, data 911, data 912, etc.) may be routed by finite state machine 926 to SRAM 930. For example, data 910, data 911, and data 912 may be routed to SRAM 930 by finite state machine 926. The address read 932 may correspond to data 910, and the address write 943 may correspond to data 912. There may be any appropriate amount of data (e.g., data N). Once all the data has been processed, the data may be output from clutch cache 920 and SRAM 930 as output data 950. In some instances, if the read address is equal to (i.e., identical to) the address, then the data may be routed from the clutch cache to the output as output data 950.

As shown in FIG. 9, the proposed cache architecture utilized herein may fill and access data from the cache (e.g., clutch cache 920) prior to those types of memory (e.g., system memory or SRAM 930). The proposed cache architecture may try to maintain the cache (e.g., clutch cache 920) to be filled with a highest efficiency or clutch depth (CD) compared to other types of memory (e.g., system memory or SRAM 930). For example, GPU 904 may keep switching of data (e.g., data 910, data 911, data 912, etc.) and/or address registers to a minimum in order to save power. In some instances, GPU 904 may keep some amount of data (e.g., data 910, data 911, data 912, etc.) inside the cache (e.g., clutch cache 920) for quick use/retrieval. If data (e.g., data 910, data 911, data 912, etc.) is needed, GPU 904 may retrieve the data (e.g., data 910, data 911, data 912, etc.) from the clutch cache 920 before retrieving data from other memory (e.g., SRAM 930). Additionally, GPU 904 may use a queue property of sequential operations (e.g., writes and reads) in a certain order (e.g., first-in, first-out (FIFO). By doing so, GPU 904 may reduce the amount of costly memory accesses. For example, GPU 904 may reduce the amount of memory accesses from certain operations (e.g., write/reads and/or out-of-order accesses).

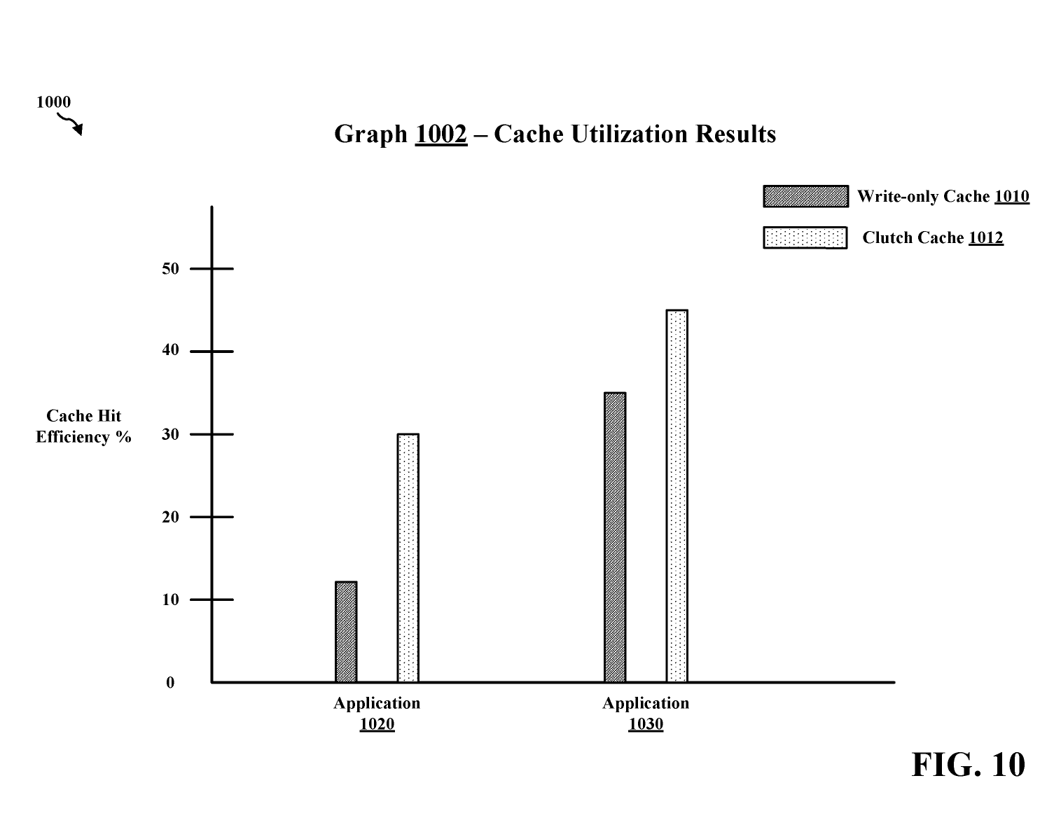

FIG. 10 is a diagram illustrating results of an example cache utilization process. More specifically, diagram 1000 depicts graph 1002 that illustrates results of an example cache utilization process for a GPU. As shown in FIG. 10, graph 1002 includes write-only cache 1010, clutch cache 1012, application 1020, and application 1030. As depicted in FIG. 10, application 1020 has a better cache hit efficiency with clutch cache 1012 compared to write-only cache 1010. For example, with clutch cache 1012, application 1020 may have a cache hit efficient percentage of 30%. With write-only cache 1010, application 1020 may have a cache hit efficient percentage of 12%. Also, application 1030 has a better cache hit efficiency with clutch cache 1012 compared to write-only cache 1010. For example, with clutch cache 1012, application 1030 may have a cache hit efficient percentage of 45%. With write-only cache 1010, application 1030 may have a cache hit efficient percentage of 35%. As such, clutch cache 1012 may allow applications to have an improved cache hit efficiency compared to other caches (e.g., write-only cache 1010).

As shown in FIG. 10, aspects presented herein may have an improved hit efficiency with clutch cache 1012 than other caches (e.g., write-only cache 1010). Also, aspects herein may do so with reduced switching for data. Further, the proposed cache architecture with clutch cache 1012 may allow a power savings (e.g., a total power savings of 24.75%). Moreover, the proposed cache architecture with clutch cache 1012 may do so with a minimal cost of additional logic. Additionally, aspects presented herein may provide an improved total cache efficiency with a certain cache depth for clutch cache 1012. For instance, aspects presented herein may provide an improved total cache efficiency with a cache depth that exceeds the hit efficiency of other caches (e.g., write-only cache 1010).

Aspects herein may utilize a number of use cases. For instance, aspects herein may utilize a workload and GPU/CPU/imaging pipeline instructions. That is, aspects herein may utilize all types of data processing through memory for instruction/data usage that follows unique patterns. In some instances, static RAM (SRAM) may be used in queues are that may depend on a benchmark workload to define efficient depth. Aspects herein may utilize rate matching of dynamic production and consumption of data by blocks. With the proposed architecture, aspects herein may use the queue properties to reduce its internal memory accesses for better power, performance, and area (PPA) at a GPU.

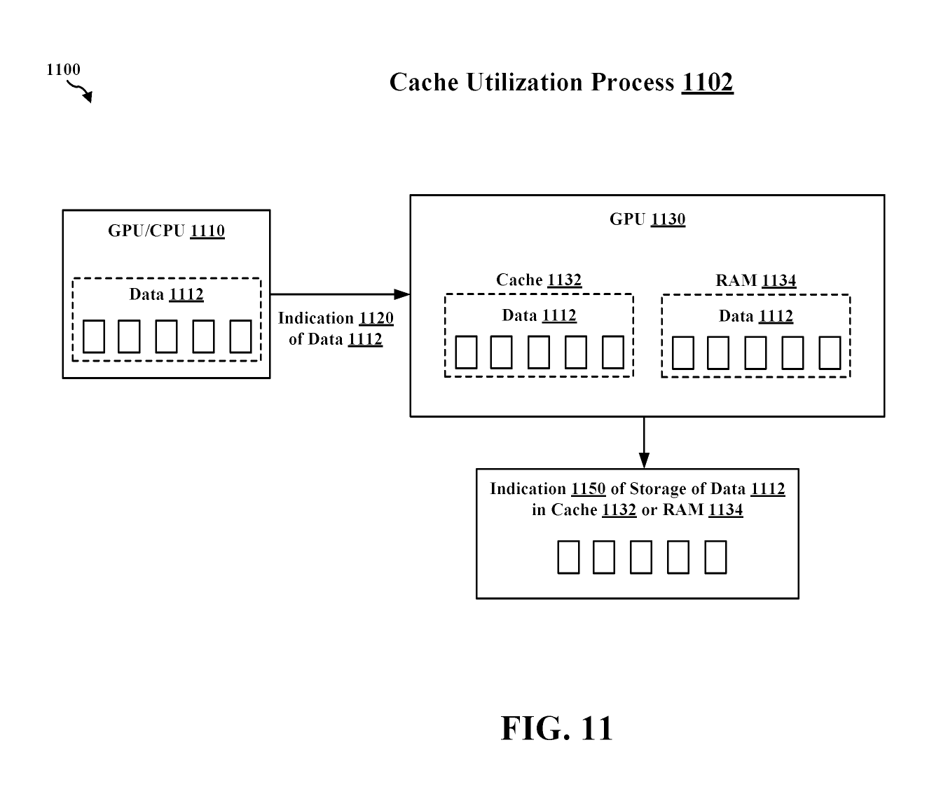

FIG. 11 illustrates diagram 1100 including one example of a cache utilization process. More specifically, diagram 1100 depicts an example cache utilization process 1102 for a GPU. As shown in FIG. 11, diagram 1100 includes GPU/CPU 1110, data 1112, indication 1120 of data 1112, GPU 1130, cache 1132, RAM 1134, and indication 1150 of storage of data 1112. As shown in FIG. 11, GPU 1130 may obtain an indication 1120 of data 1112 for a memory access process. GPU 1130 may also determine whether space is available for the data 1112 and an address of the data in a cache (e.g., a clutch cache). For example, a GPU may determine whether space is available for the data and an address of the data in a cache 1132. GPU 1130 may also store, based on space being available in the cache, the data and the address of the data in the cache 1132. GPU 1130 may also refrain from storing, based on space being unavailable in the cache, the data and the address of the data in the cache 1132. Further, GPU 1130 may refrain from storing, based on space being unavailable in the cache, the data and the address of the data in the cache 1132. That is, GPU 1130 may store, based on space being unavailable in the cache, the data and the address of the data in at least one memory (e.g., RAM 1134). Additionally, GPU 1130 may retrieve, based on storage of the data and the address of the data in the cache, the data and the address of the data from the cache 1132. GPU 1130 may also retrieve, based on refrainment of the storage of the data and the address of the data in the cache, the data and the address of the data from RAM 1134. Additionally, GPU 1130 may retrieve, based on refrainment of the storage of the data and the address of the data in the cache, the data and the address of the data from RAM 1134. GPU 1130 may also determine whether a requested address of the data is identical to the retrieved address of the data from the cache 1132. GPU 1130 may output, based on the requested address of the data being identical to the retrieved address of the data from the cache, the retrieved data from the cache 1132. Also, GPU 1130 may output, based on the requested address of the data not being identical to the retrieved address of the data from the cache, the retrieved data from RAM 1134. Aspects presented herein (e.g., a GPU) may also output an indication 1150 of storage of the data 1112 and the address of the data in the cache 1132 or refrainment of the storage of the data and the address of the data in the cache 1132.

Aspects of the present disclosure may include a number of benefits or advantages. Aspects of the present disclosure may utilize a certain types of caches/buffers for memory accesses. For instance, aspects presented herein may utilize a power efficient cache/buffer (e.g., a clutch cache) for memory accesses (e.g., read, write, etc.). That is, aspects presented herein may utilize a certain type of cache/buffer (e.g., a clutch cache) and bypass certain memory accesses (e.g., read, write, etc.) in order to optimize the PPA utilization at the GPU. Aspects presented herein may also optimize a priority for storing data at a certain type of cache/buffer. For example, aspects herein may optimize a priority for storing data at a certain type of cache/buffer (e.g., a clutch cache) over other types of memory (e.g., system memory or RAM). That is, aspects herein may fill certain types of caches/buffers (e.g., a clutch cache) prior to other types of memory (e.g., system memory or RAM). By doing so, aspects presented herein may utilize more efficient types of caches/buffers over less efficient types of memory (e.g., system memory or RAM). In turn, this may reduce the amount of power utilized at a GPU, increase the performance of a GPU, and increase the amount of available storage area at a GPU. Indeed, aspects presented herein may optimize the power, performance, and area (PPA) utilized at a GPU.

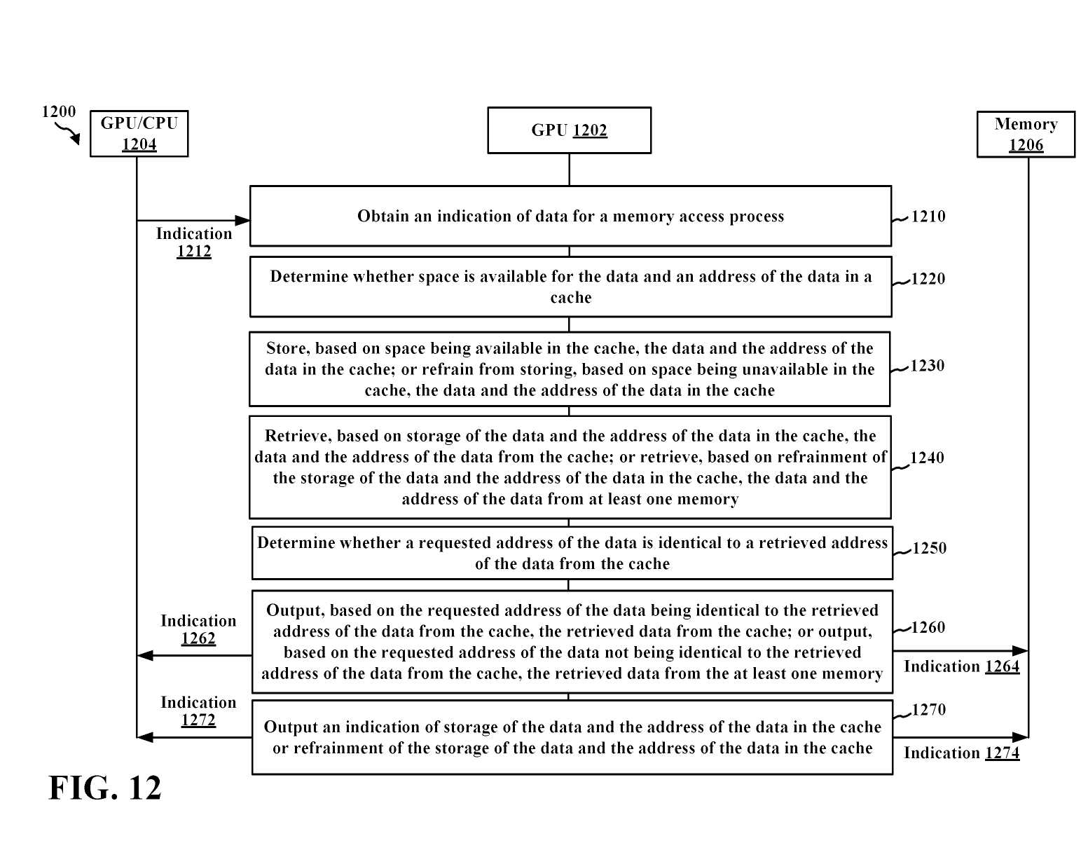

FIG. 12 is a communication flow diagram 1200 of graphics processing in accordance with one or more techniques of this disclosure. As shown in FIG. 12, diagram 1200 includes example communications between GPU 1202 (e.g., a GPU, a GPU component, or another graphics processor), GPU/CPU 1204 (e.g., a GPU, a GPU component, another graphics processor, a compiler, a CPU, a CPU component, or another central processor), and memory 1206 (e.g., a memory, a cache, a system memory, a graphics memory, a memory or cache at a CPU, or a memory or cache at a GPU), in accordance with one or more techniques of this disclosure.

At 1210, GPU 1202 may obtain an indication of data for a memory access process, where the data for the memory access process is associated with data processing. In some aspects, obtaining the indication of the data for the memory access process may comprise: receiving the indication of the data for the memory access process from at least one other component at a graphics processing unit (GPU), a central processing unit (CPU), or a display processing unit (DPU). For example, GPU 1202 may receive indication 1212 from GPU/CPU 1204. Additionally, data for the memory access process may be at least one of: graphics data, image data, display data, video data, processing data, instruction data, or data associated with an access pattern for a queue.

At 1220, GPU 1202 may determine whether space is available for the data and an address of the data in a cache. In some aspects, determining whether there is space available for the data and the address of the data in the cache may comprise: determining whether a storage capacity of the cache is greater than or equal to a storage space for the data and the address of the data. Also, determining whether the storage capacity of the cache is greater than or equal to the storage space for the data and the address of the data may comprise: determining whether an available depth of the cache is greater than or equal to the storage space for the data and the address of the data. Further, determining whether the available depth of the cache is greater than or equal to the storage space for the data and the address of the data may comprise: determining a distance from a write pointer for the available depth of the cache to a read pointer for the storage space for the data and the address of the data. In some instances, determining whether the storage capacity of the cache is greater than or equal to the storage space for the data and the address of the data may comprise: comparing the storage capacity of the cache with the storage space for the data and the address of the data; and determining whether the storage capacity of the cache is greater than or equal to the storage space for the data and the address of the data. Moreover, determining whether the storage capacity of the cache is greater than or equal to the storage space for the data and the address of the data may comprise: determining, at a finite state machine (FSM) in the cache, whether the storage capacity of the cache is greater than or equal to the storage space for the data and the address of the data. Additionally, the cache may be a clutch cache or a clutch buffer, and determining whether the storage capacity of the cache is greater than or equal to the storage space for the data and the address of the data may comprise: determining whether the storage capacity of the clutch cache or the clutch buffer is greater than or equal to the storage space for the data and the address of the data.

At 1230, GPU 1202 may store, based on space being available in the cache, the data and the address of the data in the cache; or refrain from storing, based on space being unavailable in the cache, the data and the address of the data in the cache. In some aspects, storing, based on space being available in the cache, the data and the address of the data in the cache may comprise storing the data and the address of the data in the cache; and refraining from storing the data and the address of the data in at least one memory. Also, storing the data and the address of the data in the cache; and refraining from storing the data and the address of the data in the at least one memory may comprise: writing the data and the address of the data in the cache; and refraining from storing the data and the address of the data in at least one random access memory (RAM), where the at least one RAM is at least one static RAM (SRAM) or at least one dynamic RAM (DRAM). In some aspects, refraining from storing, based on space not being available in the cache, the data and the address of the data in the cache may comprise: refraining from storing the data and the address of the data in the cache; and storing the data and the address of the data in at least one memory. Also, refraining from storing the data and the address of the data in the cache; and storing the data and the address of the data in the at least one memory may comprise: refraining from storing the data and the address of the data in the cache; and writing the data and the address of the data in at least one random access memory (RAM), where the at least one RAM is at least one static RAM (SRAM) or at least one dynamic RAM (DRAM). In some aspects, storing the data and the address of the data in the cache may comprise: writing the data and the address of the data in the cache. Additionally, refraining from storing the data and the address of the data in the cache may comprise: refraining from writing the data and the address of the data in the cache.

At 1240, GPU 1202 may retrieve, based on storage of the data and the address of the data in the cache, the data and the address of the data from the cache; or retrieve, based on refrainment of the storage of the data and the address of the data in the cache, the data and the address of the data from at least one memory. In some aspects, retrieving the data and the address of the data from the cache may comprise reading the data and the address of the data from the cache. Also, retrieving the data and the address of the data from the at least one memory may comprise reading the data and the address of the data from the at least one memory. Further, reading the data and the address of the data from the at least one memory may comprise reading the data and the address of the data from at least one random access memory (RAM). In some aspects, retrieving the data and the address of the data from the cache, or retrieving the data and the address of the data from the at least one memory may comprise: receiving a request for the data and the address of the data; and retrieving the data and the address of the data from the cache or the at least one memory.

At 1250, GPU 1202 may determine whether a requested address of the data is identical to the retrieved address of the data from the cache. For example, the GPU may determine that a requested address of the data is identical to the retrieved address of the data from the cache; or the GPU may determine that a requested address of the data is not identical to the retrieved address of the data from the cache.

At 1260, GPU 1202 may output, based on the requested address of the data being identical to the retrieved address of the data from the cache, the retrieved data from the cache; or output, based on the requested address of the data not being identical to the retrieved address of the data from the cache, the retrieved data from the at least one memory. For example, GPU 1202 may transmit indication 1262 to GPU/CPU 1204. Also, for example, GPU 1202 may store indication 1264 in memory 1206.

At 1270, GPU 1202 may output an indication of storage of the data and the address of the data in the cache or refrainment of the storage of the data and the address of the data in the cache. In some aspects, outputting the indication of the storage of the data and the address of the data in the cache or the refrainment of the storage of the data and the address of the data in the cache may comprise: transmitting the indication of the storage of the data and the address of the data in the cache or the refrainment of the storage of the data and the address of the data in the cache. For example, GPU 1202 may transmit indication 1272 to GPU/CPU 1204. Also, outputting the indication of the storage of the data and the address of the data in the cache or the refrainment of the storage of the data and the address of the data in the cache may comprise: storing the indication of the storage of the data and the address of the data in the cache or the refrainment of the storage of the data and the address of the data in the cache. For example, GPU 1202 may store indication 1274 in memory 1206.

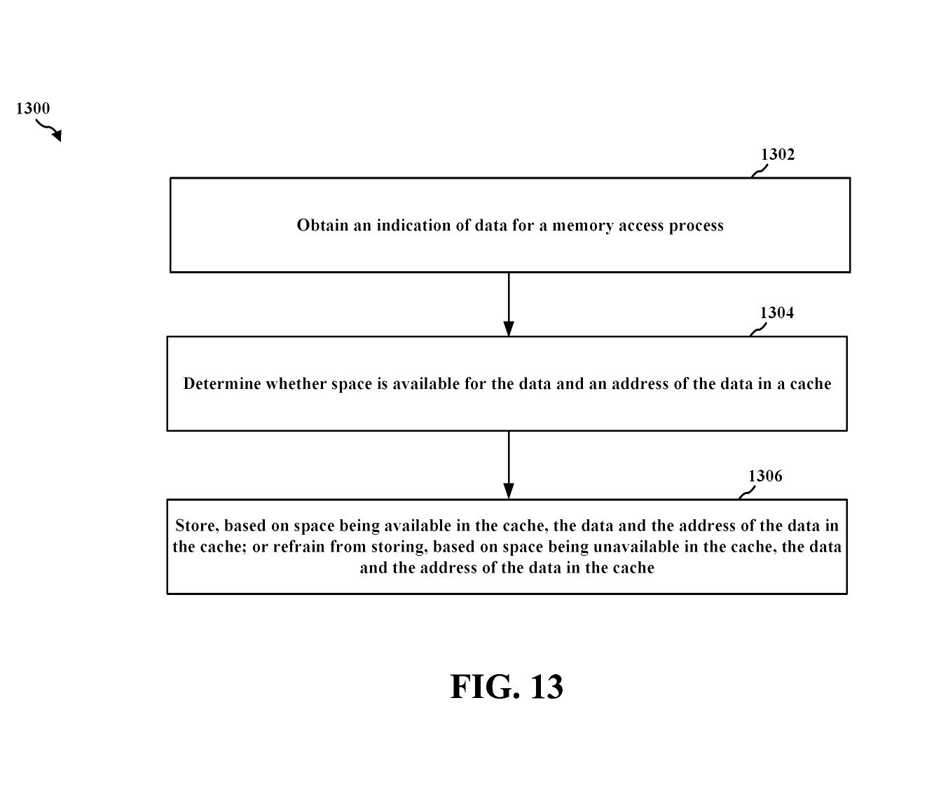

FIG. 13 is a flowchart 1300 of an example method of graphics processing in accordance with one or more techniques of this disclosure. The method may be performed by a GPU (e.g., a GPU, a compiler, a GPU component, another graphics processor, a CPU, a CPU component, or another central processor), a CPU (e.g., a CPU, a compiler, a CPU component, another central processor, a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-12.

At 1302, the GPU may obtain an indication of data for a memory access process, where the data for the memory access process is associated with data processing, as described in connection with the examples in FIGS. 1-12. For example, as described in 1210 of FIG. 12, GPU 1202 may obtain an indication of data for a memory access process, where the data for the memory access process is associated with data processing. Further, step 1302 may be performed by processing unit 120 in FIG. 1. In some aspects, obtaining the indication of the data for the memory access process may comprise: receiving the indication of the data for the memory access process from at least one other component at a graphics processing unit (GPU), a central processing unit (CPU), or a display processing unit (DPU). For example, GPU 1202 may receive indication 1212 from GPU/CPU 1204. Additionally, data for the memory access process may be at least one of: graphics data, image data, display data, video data, processing data, instruction data, or data associated with an access pattern for a queue.

At 1304, the GPU may determine whether space is available for the data and an address of the data in a cache, as described in connection with the examples in FIGS. 1-12. For example, as described in 1220 of FIG. 12, GPU 1202 may determine whether space is available for the data and an address of the data in a cache. Further, step 1304 may be performed by processing unit 120 in FIG. 1. In some aspects, determining whether there is space available for the data and the address of the data in the cache may comprise: determining whether a storage capacity of the cache is greater than or equal to a storage space for the data and the address of the data. Also, determining whether the storage capacity of the cache is greater than or equal to the storage space for the data and the address of the data may comprise: determining whether an available depth of the cache is greater than or equal to the storage space for the data and the address of the data. Further, determining whether the available depth of the cache is greater than or equal to the storage space for the data and the address of the data may comprise: determining a distance from a write pointer for the available depth of the cache to a read pointer for the storage space for the data and the address of the data. In some instances, determining whether the storage capacity of the cache is greater than or equal to the storage space for the data and the address of the data may comprise: comparing the storage capacity of the cache with the storage space for the data and the address of the data; and determining whether the storage capacity of the cache is greater than or equal to the storage space for the data and the address of the data. Moreover, determining whether the storage capacity of the cache is greater than or equal to the storage space for the data and the address of the data may comprise: determining, at a finite state machine (FSM) in the cache, whether the storage capacity of the cache is greater than or equal to the storage space for the data and the address of the data. Additionally, the cache may be a clutch cache or a clutch buffer, and determining whether the storage capacity of the cache is greater than or equal to the storage space for the data and the address of the data may comprise: determining whether the storage capacity of the clutch cache or the clutch buffer is greater than or equal to the storage space for the data and the address of the data.

At 1306, the GPU may store, based on space being available in the cache, the data and the address of the data in the cache; or refrain from storing, based on space being unavailable in the cache, the data and the address of the data in the cache, as described in connection with the examples in FIGS. 1-12. For example, as described in 1230 of FIG. 12, GPU 1202 may store, based on space being available in the cache, the data and the address of the data in the cache; or refrain from storing, based on space being unavailable in the cache, the data and the address of the data in the cache. Further, step 1306 may be performed by processing unit 120 in FIG. 1. In some aspects, storing, based on space being available in the cache, the data and the address of the data in the cache may comprise storing the data and the address of the data in the cache; and refraining from storing the data and the address of the data in at least one memory. Also, storing the data and the address of the data in the cache; and refraining from storing the data and the address of the data in the at least one memory may comprise: writing the data and the address of the data in the cache; and refraining from storing the data and the address of the data in at least one random access memory (RAM), where the at least one RAM is at least one static RAM (SRAM) or at least one dynamic RAM (DRAM). In some aspects, refraining from storing, based on space not being available in the cache, the data and the address of the data in the cache may comprise: refraining from storing the data and the address of the data in the cache; and storing the data and the address of the data in at least one memory. Also, refraining from storing the data and the address of the data in the cache; and storing the data and the address of the data in the at least one memory may comprise: refraining from storing the data and the address of the data in the cache; and writing the data and the address of the data in at least one random access memory (RAM), where the at least one RAM is at least one static RAM (SRAM) or at least one dynamic RAM (DRAM). In some aspects, storing the data and the address of the data in the cache may comprise: writing the data and the address of the data in the cache. Additionally, refraining from storing the data and the address of the data in the cache may comprise: refraining from writing the data and the address of the data in the cache.

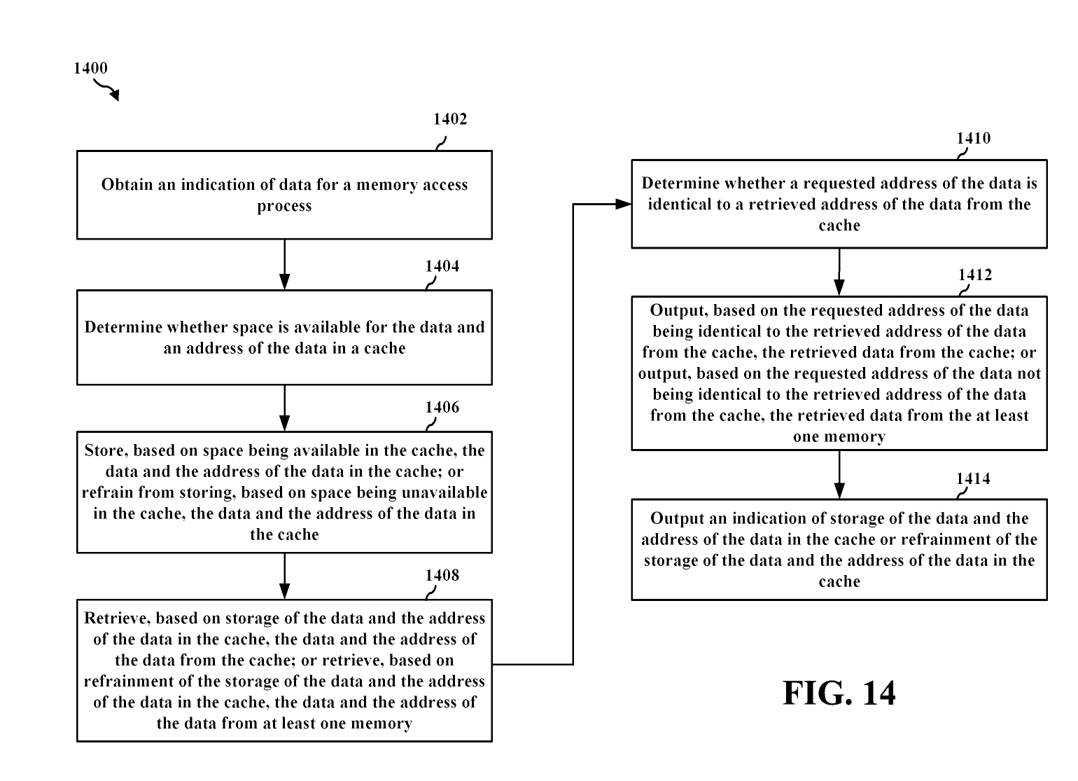

FIG. 14 is a flowchart 1400 of an example method of graphics processing in accordance with one or more techniques of this disclosure. The method may be performed by a GPU (e.g., a GPU, a compiler, a GPU component, another graphics processor, a CPU, a CPU component, or another central processor), a CPU (e.g., a CPU, a compiler, a CPU component, another central processor, a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-12.

At 1402, the GPU may obtain an indication of data for a memory access process, where the data for the memory access process is associated with data processing, as described in connection with the examples in FIGS. 1-12. For example, as described in 1210 of FIG. 12, GPU 1202 may obtain an indication of data for a memory access process, where the data for the memory access process is associated with data processing. Further, step 1402 may be performed by processing unit 120 in FIG. 1. In some aspects, obtaining the indication of the data for the memory access process may comprise: receiving the indication of the data for the memory access process from at least one other component at a graphics processing unit (GPU), a central processing unit (CPU), or a display processing unit (DPU). For example, GPU 1202 may receive indication 1212 from GPU/CPU 1204. Additionally, data for the memory access process may be at least one of: graphics data, image data, display data, video data, processing data, instruction data, or data associated with an access pattern for a queue.

At 1404, the GPU may determine whether space is available for the data and an address of the data in a cache, as described in connection with the examples in FIGS. 1-12. For example, as described in 1220 of FIG. 12, GPU 1202 may determine whether space is available for the data and an address of the data in a cache. Further, step 1404 may be performed by processing unit 120 in FIG. 1. In some aspects, determining whether there is space available for the data and the address of the data in the cache may comprise: determining whether a storage capacity of the cache is greater than or equal to a storage space for the data and the address of the data. Also, determining whether the storage capacity of the cache is greater than or equal to the storage space for the data and the address of the data may comprise: determining whether an available depth of the cache is greater than or equal to the storage space for the data and the address of the data. Further, determining whether the available depth of the cache is greater than or equal to the storage space for the data and the address of the data may comprise: determining a distance from a write pointer for the available depth of the cache to a read pointer for the storage space for the data and the address of the data. In some instances, determining whether the storage capacity of the cache is greater than or equal to the storage space for the data and the address of the data may comprise: comparing the storage capacity of the cache with the storage space for the data and the address of the data; and determining whether the storage capacity of the cache is greater than or equal to the storage space for the data and the address of the data. Moreover, determining whether the storage capacity of the cache is greater than or equal to the storage space for the data and the address of the data may comprise: determining, at a finite state machine (FSM) in the cache, whether the storage capacity of the cache is greater than or equal to the storage space for the data and the address of the data. Additionally, the cache may be a clutch cache or a clutch buffer, and determining whether the storage capacity of the cache is greater than or equal to the storage space for the data and the address of the data may comprise: determining whether the storage capacity of the clutch cache or the clutch buffer is greater than or equal to the storage space for the data and the address of the data.

At 1406, the GPU may store, based on space being available in the cache, the data and the address of the data in the cache; or refrain from storing, based on space being unavailable in the cache, the data and the address of the data in the cache, as described in connection with the examples in FIGS. 1-12. For example, as described in 1230 of FIG. 12, GPU 1202 may store, based on space being available in the cache, the data and the address of the data in the cache; or refrain from storing, based on space being unavailable in the cache, the data and the address of the data in the cache. Further, step 1406 may be performed by processing unit 120 in FIG. 1. In some aspects, storing, based on space being available in the cache, the data and the address of the data in the cache may comprise storing the data and the address of the data in the cache; and refraining from storing the data and the address of the data in at least one memory. Also, storing the data and the address of the data in the cache; and refraining from storing the data and the address of the data in the at least one memory may comprise: writing the data and the address of the data in the cache; and refraining from storing the data and the address of the data in at least one random access memory (RAM), where the at least one RAM is at least one static RAM (SRAM) or at least one dynamic RAM (DRAM). In some aspects, refraining from storing, based on space not being available in the cache, the data and the address of the data in the cache may comprise: refraining from storing the data and the address of the data in the cache; and storing the data and the address of the data in at least one memory. Also, refraining from storing the data and the address of the data in the cache; and storing the data and the address of the data in the at least one memory may comprise: refraining from storing the data and the address of the data in the cache; and writing the data and the address of the data in at least one random access memory (RAM), where the at least one RAM is at least one static RAM (SRAM) or at least one dynamic RAM (DRAM). In some aspects, storing the data and the address of the data in the cache may comprise: writing the data and the address of the data in the cache. Additionally, refraining from storing the data and the address of the data in the cache may comprise: refraining from writing the data and the address of the data in the cache.

At 1408, the GPU may retrieve, based on storage of the data and the address of the data in the cache, the data and the address of the data from the cache; or retrieve, based on refrainment of the storage of the data and the address of the data in the cache, the data and the address of the data from at least one memory, as described in connection with the examples in FIGS. 1-12. For example, as described in 1240 of FIG. 12, GPU 1202 may retrieve, based on storage of the data and the address of the data in the cache, the data and the address of the data from the cache; or retrieve, based on refrainment of the storage of the data and the address of the data in the cache, the data and the address of the data from at least one memory. Further, step 1408 may be performed by processing unit 120 in FIG. 1. In some aspects, retrieving the data and the address of the data from the cache may comprise reading the data and the address of the data from the cache. Also, retrieving the data and the address of the data from the at least one memory may comprise reading the data and the address of the data from the at least one memory. Further, reading the data and the address of the data from the at least one memory may comprise reading the data and the address of the data from at least one random access memory (RAM). In some aspects, retrieving the data and the address of the data from the cache, or retrieving the data and the address of the data from the at least one memory may comprise: receiving a request for the data and the address of the data; and retrieving the data and the address of the data from the cache or the at least one memory.

At 1410, the GPU may determine whether a requested address of the data is identical to the retrieved address of the data from the cache, as described in connection with the examples in FIGS. 1-12. For example, as described in 1250 of FIG. 12, GPU 1202 may determine whether a requested address of the data is identical to the retrieved address of the data from the cache. Further, step 1410 may be performed by processing unit 120 in FIG. 1. For example, the GPU may determine that a requested address of the data is identical to the retrieved address of the data from the cache; or the GPU may determine that a requested address of the data is not identical to the retrieved address of the data from the cache.

At 1412, the GPU may output, based on the requested address of the data being identical to the retrieved address of the data from the cache, the retrieved data from the cache; or output, based on the requested address of the data not being identical to the retrieved address of the data from the cache, the retrieved data from the at least one memory, as described in connection with the examples in FIGS. 1-12. For example, as described in 1260 of FIG. 12, GPU 1202 may output, based on the requested address of the data being identical to the retrieved address of the data from the cache, the retrieved data from the cache; or output, based on the requested address of the data not being identical to the retrieved address of the data from the cache, the retrieved data from the at least one memory. Further, step 1412 may be performed by processing unit 120 in FIG. 1. For example, GPU 1202 may transmit indication 1262 to GPU/CPU 1204. Also, for example, GPU 1202 may store indication 1264 in memory 1206.

At 1414, the GPU may output an indication of storage of the data and the address of the data in the cache or refrainment of the storage of the data and the address of the data in the cache, as described in connection with the examples in FIGS. 1-12. For example, as described in 1270 of FIG. 12, GPU 1202 may output an indication of storage of the data and the address of the data in the cache or refrainment of the storage of the data and the address of the data in the cache. Further, step 1414 may be performed by processing unit 120 in FIG. 1. In some aspects, outputting the indication of the storage of the data and the address of the data in the cache or the refrainment of the storage of the data and the address of the data in the cache may comprise: transmitting the indication of the storage of the data and the address of the data in the cache or the refrainment of the storage of the data and the address of the data in the cache. For example, GPU 1202 may transmit indication 1272 to GPU/CPU 1204. Also, outputting the indication of the storage of the data and the address of the data in the cache or the refrainment of the storage of the data and the address of the data in the cache may comprise: storing the indication of the storage of the data and the address of the data in the cache or the refrainment of the storage of the data and the address of the data in the cache. For example, GPU 1202 may store indication 1274 in memory 1206.

In configurations, a method or an apparatus for data or graphics processing is provided. The apparatus may be a GPU (or other graphics processor), a CPU (or other central processor), a DDIC, an apparatus for graphics processing, and/or some other processor that may perform data or graphics processing. In aspects, the apparatus may be the processing unit 120 within the device 104, or may be some other hardware within the device 104 or another device. The apparatus, e.g., processing unit 120, may include means for obtaining an indication of data for a memory access process, where the data for the memory access process is associated with data processing. The apparatus, e.g., processing unit 120, may also include means for determining whether space is available for the data and an address of the data in a cache. The apparatus, e.g., processing unit 120, may also include means for storing, based on space being available in the cache, the data and the address of the data in the cache; or means for refraining from storing, based on space being unavailable in the cache, the data and the address of the data in the cache. The apparatus, e.g., processing unit 120, may also include means for retrieving, based on storage of the data and the address of the data in the cache, the data and the address of the data from the cache; or means for retrieving, based on refrainment of the storage of the data and the address of the data in the cache, the data and the address of the data from at least one memory. The apparatus, e.g., processing unit 120, may also include means for determining whether the requested address of the data is identical to the retrieved address of the data from the cache. The apparatus, e.g., processing unit 120, may also include means for outputting, based on the requested address of the data being identical to the retrieved address of the data from the cache, the retrieved data from the cache; or means for outputting, based on the requested address of the data not being identical to the retrieved address of the data from the cache, the retrieved data from the at least one memory. The apparatus, e.g., processing unit 120, may also include means for outputting an indication of storage of the data and the address of the data in the cache or refrainment of the storage of the data and the address of the data in the cache.

The subject matter described herein may be implemented to realize one or more benefits or advantages. For instance, the described graphics processing techniques may be used by a GPU, a CPU, a central processor, or some other processor that may perform graphics processing to implement the cache utilization techniques described herein. This may also be accomplished at a low cost compared to other graphics processing techniques. Moreover, the graphics processing techniques herein may improve or speed up graphics processing or execution. Further, the graphics processing techniques herein may improve resource or data utilization and/or resource efficiency. Additionally, aspects of the present disclosure may utilize cache utilization techniques in order to improve memory bandwidth efficiency and/or increase processing speed at a GPU, a CPU, or a DPU.

It is understood that the specific order or hierarchy of blocks in the processes / flowcharts disclosed is an illustration of example approaches. Based upon design preferences, it is understood that the specific order or hierarchy of blocks in the processes / flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing, including at least one memory and at least one processor coupled to the at least one memory and, based at least in part on information stored in the at least one memory, the at least one processor, individually or in any combination, is configured to: obtain an indication of data for a memory access process, wherein the data for the memory access process is associated with data processing; determine whether space is available for the data and an address of the data in a cache; and store, based on space being available in the cache, the data and the address of the data in the cache; or refrain from storing, based on space being unavailable in the cache, the data and the address of the data in the cache.

Aspect 2 is the apparatus of aspect 1, wherein to determine whether there is space available for the data and the address of the data in the cache, the at least one processor is configured to: determine whether a storage capacity of the cache is greater than or equal to a storage space for the data and the address of the data.

Aspect 3 is the apparatus of aspect 2, wherein to determine whether the storage capacity of the cache is greater than or equal to the storage space for the data and the address of the data, the at least one processor is configured to: determine whether an available depth of the cache is greater than or equal to the storage space for the data and the address of the data.

Aspect 4 is the apparatus of aspect 3, wherein to determine whether the available depth of the cache is greater than or equal to the storage space for the data and the address of the data, the at least one processor is configured to: determine a distance from a write pointer for the available depth of the cache to a read pointer for the storage space for the data and the address of the data.

Aspect 5 is the apparatus of any of aspects 2 to 4, wherein to determine whether the storage capacity of the cache is greater than or equal to the storage space for the data and the address of the data, the at least one processor is configured to: compare the storage capacity of the cache with the storage space for the data and the address of the data; and determine whether the storage capacity of the cache is greater than or equal to the storage space for the data and the address of the data.

Aspect 6 is the apparatus of any of aspects 2 to 5, wherein to determine whether the storage capacity of the cache is greater than or equal to the storage space for the data and the address of the data, the at least one processor is configured to: determine, at a finite state machine (FSM) in the cache, whether the storage capacity of the cache is greater than or equal to the storage space for the data and the address of the data.

Aspect 7 is the apparatus of any of aspects 2 to 6, wherein the cache is a clutch cache or a clutch buffer, and wherein to determine whether the storage capacity of the cache is greater than or equal to the storage space for the data and the address of the data, the at least one processor is configured to: determine whether the storage capacity of the clutch cache or the clutch buffer is greater than or equal to the storage space for the data and the address of the data.

Aspect 8 is the apparatus of any of aspects 1 to 7, wherein the at least one processor is further configured to: retrieve, based on storage of the data and the address of the data in the cache, the data and the address of the data from the cache; or retrieve, based on refrainment of the storage of the data and the address of the data in the cache, the data and the address of the data from at least one memory.

Aspect 9 is the apparatus of aspect 8, wherein to retrieve the data and the address of the data from the cache, the at least one processor is configured to: read the data and the address of the data from the cache; and wherein to retrieve the data and the address of the data from the at least one memory, the at least one processor is configured to: read the data and the address of the data from the at least one memory.

Aspect 10 is the apparatus of aspect 9, wherein to read the data and the address of the data from the at least one memory, the at least one processor is configured to: read the data and the address of the data from at least one random access memory (RAM).

Aspect 11 is the apparatus of any of aspects 8 to 10, wherein to retrieve the data and the address of the data from the cache, or retrieve the data and the address of the data from the at least one memory, the at least one processor is configured to: receive a request for the data and the address of the data; and retrieve the data and the address of the data from the cache or the at least one memory.

Aspect 12 is the apparatus of aspect 11, wherein the at least one processor is further configured to: determine whether the requested address of the data is identical to the retrieved address of the data from the cache.

Aspect 13 is the apparatus of aspect 12, wherein the at least one processor is further configured to: output, based on the requested address of the data being identical to the retrieved address of the data from the cache, the retrieved data from the cache; or output, based on the requested address of the data not being identical to the retrieved address of the data from the cache, the retrieved data from the at least one memory.

Aspect 14 is the apparatus of any of aspects 1 to 13, wherein to store, based on space being available in the cache, the data and the address of the data in the cache, the at least one processor is configured to: store the data and the address of the data in the cache; and refrain from storing the data and the address of the data in at least one memory.

Aspect 15 is the apparatus of aspect 14, wherein to store the data and the address of the data in the cache; and refrain from storing the data and the address of the data in the at least one memory, the at least one processor is configured to: write the data and the address of the data in the cache; and refrain from storing the data and the address of the data in at least one random access memory (RAM), wherein the at least one RAM is at least one static RAM (SRAM) or at least one dynamic RAM (DRAM).

Aspect 16 is the apparatus of any of aspects 1 to 15, wherein to refrain from storing, based on space not being available in the cache, the data and the address of the data in the cache, the at least one processor is configured to: refrain from storing the data and the address of the data in the cache; and store the data and the address of the data in at least one memory.

Aspect 17 is the apparatus of aspect 16, wherein to refrain from storing the data and the address of the data in the cache; and store the data and the address of the data in the at least one memory, the at least one processor is configured to: refrain from storing the data and the address of the data in the cache; and write the data and the address of the data in at least one random access memory (RAM), wherein the at least one RAM is at least one static RAM (SRAM) or at least one dynamic RAM (DRAM).

Aspect 18 is the apparatus of any of aspects 1 to 17, wherein to store the data and the address of the data in the cache, the at least one processor is configured to: write the data and the address of the data in the cache; and wherein to refrain from storing the data and the address of the data in the cache, the at least one processor is configured to: refrain from writing the data and the address of the data in the cache.

Aspect 19 is the apparatus of any of aspects 1 to 18, wherein to obtain the indication of the data for the memory access process, the at least one processor is configured to: receive the indication of the data for the memory access process from at least one other component at a graphics processing unit (GPU), a central processing unit (CPU), or a display processing unit (DPU).

Aspect 20 is the apparatus of any of aspects 1 to 19, wherein the data for the memory access process is at least one of: graphics data, image data, display data, video data, processing data, instruction data, or data associated with an access pattern for a queue.

Aspect 21 is the apparatus of any of aspects 1 to 20, wherein the at least one processor is further configured to: output an indication of storage of the data and the address of the data in the cache or refrainment of the storage of the data and the address of the data in the cache.

Aspect 22 is the apparatus of aspect 21, wherein to output the indication of the storage of the data and the address of the data in the cache or the refrainment of the storage of the data and the address of the data in the cache, the at least one processor is configured to: transmit the indication of the storage of the data and the address of the data in the cache or the refrainment of the storage of the data and the address of the data in the cache; or store the indication of the storage of the data and the address of the data in the cache or the refrainment of the storage of the data and the address of the data in the cache.

Aspect 23 is the apparatus of aspect 22, further including (i.e., comprising) at least one of an antenna or a transceiver coupled to the at least one processor, wherein to transmit the indication of the storage of the data and the address of the data in the cache or the refrainment of the storage of the data and the address of the data in the cache, the at least one processor is configured to: transmit, via at least one of an antenna or a transceiver, the indication of the storage of the data and the address of the data in the cache or the refrainment of the storage of the data and the address of the data in the cache.

Aspect 24 is the apparatus of any of aspects 1 to 23, wherein the apparatus is a wireless communication device.

Aspect 25 is a method of graphics processing for implementing any of aspects 1 to 23.

Aspect 26 is an apparatus for graphics processing including means for implementing any of aspects 1 to 23.

Aspect 27 is a computer-readable medium (e.g., a non-transitory computer-readable medium) storing computer executable code (e.g., code for graphics processing), the code when executed by at least one processor causes the at least one processor to implement any of aspects 1 to 23.

What is claimed is:

1. An apparatus for graphics processing, comprising:
at least one first memory; and
at least one processor coupled to the at least one first memory and, based at least in part on information stored in the at least one first memory, the at least one processor is configured to:
obtain an indication of data for a memory access process, wherein the data for the memory access process is associated with data processing;
determine whether space is available for the data and an address of the data in a cache; and
store, based on space being available in the cache, the data and the address of the data in the cache; or refrain from storing, based on space being unavailable in the cache, the data and the address of the data in the cache.

2. The apparatus of claim 1, wherein to determine whether there is space available for the data and the address of the data in the cache, the at least one processor is configured to:
determine whether a storage capacity of the cache is greater than or equal to a storage space for the data and the address of the data.

3. The apparatus of claim 2, wherein to determine whether the storage capacity of the cache is greater than or equal to the storage space for the data and the address of the data, the at least one processor is configured to:
determine whether an available depth of the cache is greater than or equal to the storage space for the data and the address of the data.

4. The apparatus of claim 3, wherein to determine whether the available depth of the cache is greater than or equal to the storage space for the data and the address of the data, the at least one processor is configured to:
determine a distance from a write pointer for the available depth of the cache to a read pointer for the storage space for the data and the address of the data.

5. The apparatus of claim 2, wherein to determine whether the storage capacity of the cache is greater than or equal to the storage space for the data and the address of the data, the at least one processor is configured to:
compare the storage capacity of the cache with the storage space for the data and the address of the data; and
determine whether the storage capacity of the cache is greater than or equal to the storage space for the data and the address of the data.

6. The apparatus of claim 2, wherein to determine whether the storage capacity of the cache is greater than or equal to the storage space for the data and the address of the data, the at least one processor is configured to:
determine, at a finite state machine (FSM) in the cache, whether the storage capacity of the cache is greater than or equal to the storage space for the data and the address of the data.

7. The apparatus of claim 2, wherein the cache is a clutch cache or a clutch buffer, and wherein to determine whether the storage capacity of the cache is greater than or equal to the storage space for the data and the address of the data, the at least one processor is configured to:
determine whether the storage capacity of the clutch cache or the clutch buffer is greater than or equal to the storage space for the data and the address of the data.

8. The apparatus of claim 1, wherein the at least one processor is further configured to:
retrieve, based on storage of the data and the address of the data in the cache, the data and the address of the data from the cache; or
retrieve, based on refrainment of the storage of the data and the address of the data in the cache, the data and the address of the data from at least one memory.

9. The apparatus of claim 8, wherein to retrieve the data and the address of the data from the cache, the at least one processor is configured to: read the data and the address of the data from the cache; and
wherein to retrieve the data and the address of the data from the at least one memory, the at least one processor is configured to: read the data and the address of the data from the at least one memory.

10. The apparatus of claim 9, wherein to read the data and the address of the data from the at least one memory, the at least one processor is configured to:
read the data and the address of the data from at least one random access memory (RAM).

11. The apparatus of claim 8, wherein to retrieve the data and the address of the data from the cache, or retrieve the data and the address of the data from the at least one memory, the at least one processor is configured to:
receive a request for the data and the address of the data; and
retrieve the data and the address of the data from the cache or the at least one memory.

12. The apparatus of claim 11, wherein the at least one processor is further configured to:
determine whether the requested address of the data is identical to the retrieved address of the data from the cache.

13. The apparatus of claim 12, wherein the at least one processor is further configured to:
output, based on the requested address of the data being identical to the retrieved address of the data from the cache, the retrieved data from the cache; or
output, based on the requested address of the data not being identical to the retrieved address of the data from the cache, the retrieved data from the at least one memory.

14. The apparatus of claim 1, wherein to store, based on space being available in the cache, the data and the address of the data in the cache, the at least one processor is configured to:
store the data and the address of the data in the cache; and
refrain from storing the data and the address of the data in at least one memory, wherein the at least one memory is at least one static random access memory (RAM) (SRAM) or at least one dynamic RAM (DRAM).

15. The apparatus of claim 1, wherein to refrain from storing, based on space not being available in the cache, the data and the address of the data in the cache, the at least one processor is configured to:
refrain from storing the data and the address of the data in the cache; and
store the data and the address of the data in at least one memory, wherein the at least one memory is at least one static random access memory (RAM) (SRAM) or at least one dynamic RAM (DRAM).

16. The apparatus of claim 1, wherein to store the data and the address of the data in the cache, the at least one processor is configured to: write the data and the address of the data in the cache; and
wherein to refrain from storing the data and the address of the data in the cache, the at least one processor is configured to: refrain from writing the data and the address of the data in the cache.

17. The apparatus of claim 1, wherein to obtain the indication of the data for the memory access process, the at least one processor is configured to:
receive the indication of the data for the memory access process from at least one other component at a graphics processing unit (GPU), a central processing unit (CPU), or a display processing unit (DPU), wherein the data for the memory access process is at least one of: graphics data, image data, display data, video data, processing data, instruction data, or data associated with an access pattern for a queue.

18. The apparatus of claim 1, wherein the at least one processor is further configured to:
output an indication of storage of the data and the address of the data in the cache or refrainment of the storage of the data and the address of the data in the cache.

19. A method of graphics processing, comprising:
obtaining an indication of data for a memory access process, wherein the data for the memory access process is associated with data processing;
determining whether space is available for the data and an address of the data in a cache; and
storing, based on space being available in the cache, the data and the address of the data in the cache; or refraining from storing, based on space being unavailable in the cache, the data and the address of the data in the cache.

20. A computer-readable medium storing computer executable code for graphics processing, the code when executed by at least one processor causes the at least one processor to:
obtain an indication of data for a memory access process, wherein the data for the memory access process is associated with data processing;
determine whether space is available for the data and an address of the data in a cache; and
store, based on space being available in the cache, the data and the address of the data in the cache; or refrain from storing, based on space being unavailable in the cache, the data and the address of the data in the cache.
